(19) United States
(12) Patent Application Publication
(10) Pub. No.: US 2013/0061138 A1
(43) Pub. Date: Mar. 7, 2013

(54) METHOD AND SYSTEM FOR CREATING A STEP-BY-STEP INSTRUCTION GUIDE

(71) Applicant: Scott L. SPECTOR, Washington, DC (US)

(72) Inventor: Scott L. SPECTOR, Washington, DC (US)

(21) Appl. No.: 13/599,535

(22) Filed: Aug. 30, 2012

Related U.S. Application Data
(60) Provisional application No. 61/529,315, filed on Aug. 31, 2011.

(51) Int. Cl. G06F 17/24

(52) U.S. Cl. 715/256

(57) ABSTRACT

A step-by-step electronic instruction guide is created for users to learn, operate, and perform a wide variety of tasks. The step-by-step instructions are created, edited, published, and shared using an interactive template and intuitive user interface to provide explanations and information of interest. Users integrate images, text, and audio and visual materials to create discrete steps of an instruction manual. The individual steps are created and stored on a computing device and database, where they can be edited, assembled, distributed, and communicated to other users. The computing device includes storage devices, display devices, and processors that create, store, retrieve, and display step-by-step instructions. The computing device includes editing and control modules that access, manipulate, and present the step-by-step instructions and a graphics module that receives the instructions from the database and processor and outputs a visual and/or audio depiction of the step-by-step instructions.

### CROSS-REFERENCE TO RELATED APPLICATION

This application claims benefit of priority of U.S. Provisional Patent Application Ser. No. 61/529,315 filed on Aug. 31, 2011, the entire disclosure of which is incorporated herein by reference.

### TECHNICAL FIELD

This technology relates to an electronic instruction manual display apparatus and methods for creating electronic instruction manuals. More particularly, the technology relates to systems, computing devices, and methods of creating, editing, publishing, and sharing step-by-step electronic instruction manuals.

### BACKGROUND

Instruction manuals provide information to accomplish or to learn how to accomplish a specific task. Instruction manuals can provide directions for assembling, operating, or troubleshooting a product, for example. Instruction manuals can provide systematic approaches to installing, operating, or repairing a product or a device and can also provide hints, tips, and warnings related to the product or device. Similarly, instruction manuals can provide an overview of the operation of the product or device and an appendix. Instruction manuals can also serve as reference materials for a user when the user has difficulty operating the product in the future.

Instruction manuals often exist as a sequence of lines of text in printed format, or as online documents that can be viewed on a computer terminal or other display device. Instruction manuals can exist as web-based documentation as well, where users provide information and collaboration. Many web-based instruction manuals are approximations of previous printed matter manuals, while others are simply narrated running videos of a user attempting to perform a particular task. A number of web sites have been created to house the instruction manuals and videos once they are created, but the created manuals lack consistency both in the content provided and in the manner in which the content is accessed. As communities of users continue to grow, many users wish to provide and use instructions regarding particular tasks or devices.

### SUMMARY

The systems, computing devices, and methods of the claimed invention provide an inviting interaction for users to learn, operate, and perform a wide variety of tasks. Not only are step-by-step instruction manuals created for particular devices but step-by-step instructions are created and tailored to particular groups of users to provide explanations and information of interest. In particular, the systems and methods of the claimed invention provide an interactive template for users to create and manage instruction manuals.

The step-by-step instruction manuals are created with devices and methods and a process app that allows users to create easy-to-use sets of step-by-step-instructions where photos/video are directly associated with a particular step in a list of instructions. The step-by-step instructions in the claimed invention provide a clear breakdown of the individual steps required for a certain task. With the instruction templates of the claimed invention, text, images, and audio are easily customized and organized to provide a clear set of instructions.

The ability to create, edit, and share a step-by-step instruction manual on a mobile computing device allows users to bring the manual to the task at hand. Likewise, the project in front of the user can be used to check and verify the accuracy of the created step-by-step instructions. The instructions can be made portable and then shared (via a PDF document, for example) with other users.

The systems, devices, and methods for creating a step-by-step instruction guide in accordance with the claimed invention enable users to create, edit, publish, and share instruction guides that include images, text, and other audio and visual materials. The instruction guides include a number of instruction steps created by the user. An intuitive user interface on a computing device provides a platform for creating the individual instruction steps including integrated materials to provide instruction and information to a user. The individual steps are created and stored on a computing device and database, where they can be edited, assembled, distributed, and communicated to other users. The computing device includes a storage device, such as a computer memory and/or database, a display device, such as a display screen or other I/O device, and a computer processor that creates, stores, retrieves, and displays step-by-step instructions. The computing device processor includes editing and control modules that access, manipulate, and present the step-by-step instructions from the database as well as a graphics module that receives the instructions from the database and processor and outputs a visual and/or audio depiction of the step-by-step instructions to the display screen. A network interface controller is also provided in the computing device to implement, manage, and communicate with other computing devices, such as over a communications network, for example.

In one example embodiment, a user inputs text in a displayed field using a computing device, such as a smart phone, tablet computer, and the like. One example portable computing device is an iPad®, manufactured by Apple Inc. of Cupertino, Calif. On the same display screen of the computing device, the user can import relevant images from a database or take new images with the computing device and incorporate the image(s) with the inputted text to create a step in the instruction guide. That is, the text and images on one screen form a single “step” within a step-by-step instruction guide. The created step is stored in a database in memory.

The user adds additional steps, including additional text, audio, and video materials, to create the step-by-step compilation that is the instructional guide. The user can edit the individual steps by adding, deleting, or changing the component text, audio, or visual materials. The user can edit the order of the steps at any time using a drag-and-drop interface on the computing device. Once the user has entered all the relevant text and images for all steps and has made any needed adjustments to the order of the steps, the user can export or publish the entire step-by-step guide as a PDF (portable document format) document or in other formats. Likewise, the user can share or otherwise collaborate with other users and/or other groups of users based upon like interests, group memberships, geographical commonalities, and other similar distribution criteria.

The devices and methods in accordance with the claimed invention provide pre-formatted step-by-step instruction manual templates in which text, photographs, videos, audio materials, and other instructional materials can be incorporated into a display. Multiple authors can utilize the devices and methods of the claimed invention to collaborate in the creation, editing, and distribution of the step-by-step instruction manuals.

One example embodiment of the claimed invention includes a computer-implemented method of creating a step-by-step instruction manual. The method is performed at a portable electronic step-by-step computing device with a touch screen display and includes displaying a title page template on the touch screen display, where the title page includes a title space. The example method further includes detecting an entered title in the title space and a first finger tap gesture at a location on the displayed title page template. The finger tap gesture can include a single finger tap, multiple finger taps, swiping gestures, and the like. The example method also includes displaying a step screen page template on the touch screen display, where the step screen page includes a step block and an attachment block. An entered step in the step block and a second finger tap gesture at a location on the displayed step screen page template are detected, and the method stores a step-by-step instruction manual in a database based upon the entered title and/or the entered step.

One example embodiment of the claimed invention can also include a computer-implemented method of creating a step-by-step instruction manual that also includes detecting an additional finger tap gesture at the attachment block on the displayed step screen page template, receiving a selected attachment file from a database, and displaying a visual representation of the selected attachment file in the displayed attachment block on the portable computing device. The attachment file can include a photographic file, a video file, and/or an audio file. Similarly, one example embodiment of the claimed invention can include detecting an additional finger tap gesture at the attachment block on the displayed step screen page template, creating an attachment file with the portable electronic step-by-step computing device, and displaying a visual representation of the created attachment file in the displayed attachment block. As above, the created attachment file can include a photographic file, a video file, and/or an audio file.

When storing the step-by-step instruction manual, one example embodiment of the claimed invention stores the manual in a database in the portable electronic step-by-step computing device. Storing the manual can include identifying title and step data associated with the step-by-step instruction manual. The step data can include information related to the particular steps of the instruction manual, such as the step order, step name, and other information used to characterize the step and its place in the manual. Storing the manual can also include creating a main table of the title and step data including a step-by-step ID, a name, and a date on which the step-by-step instruction manual was stored. Additionally, storing the manual can include creating a steps table including step text, guide ID, and step number data, and the step ID as well as creating a local path table that includes local paths to attachment files used within a step. The title and step data associated with the step-by-step instruction manual can be indexed in a local app database in the portable electronic step-by-step computing device.

One example embodiment of the claimed invention can also include a computer-implemented method of creating a step-by-step instruction manual that also includes displaying a roadmap block on the touch screen display, where the roadmap block includes a title block and a step 1 block. The roadmap block provides a visual depiction of where in the step-by-step instruction guide the user is working. In one example embodiment, as a user adds additional steps to the guide, an additional step screen page template is displayed on the touch screen display. The additional step screen page includes an additional step block and an additional attachment block. The method detects an entered additional step in the additional step block and an additional finger tap gesture at a location on the displayed step screen page template. The method also includes updating the displayed roadmap block on the touch screen display.

One example embodiment of the claimed invention includes a portable electronic step-by-step computing device with a touch screen display, a processor, a memory, and at least one program, where the program(s) is stored in the memory and configured to be executed by the processor. The program(s) includes instructions for displaying a title page template on the touch screen display, where the title page includes a title space. The programs also include instructions for detecting an entered title in the title space and a first finger tap gesture at a location on the displayed title page template. The programs further include instructions for displaying a step screen page template on the touch screen display, where the step screen page includes a step block and an attachment block and instructions for detecting an entered step in the step block and a second finger tap gesture at a location on the displayed step screen page template. The programs further include instructions for storing a step-by-step instruction manual in a database based upon the entered title and/or the entered step.

One example embodiment of the claimed invention can also include a portable electronic step-by-step computing device where the programs further include instructions for detecting an additional finger tap gesture at the attachment block on the displayed step screen page template, instructions for receiving a selected attachment file from a database, and instructions for displaying a visual representation of the selected attachment file in the displayed attachment block. Likewise, the programs can include instructions for detecting an additional finger tap gesture at the attachment block on the displayed step screen page template, instructions for creating an attachment file with the portable electronic step-by-step computing device, and instructions for displaying a visual representation of the created attachment file in the displayed attachment block. As above, the selected attachment file and/or the created attachment file can include at least one of a photographic file, a video file, and an audio file.

One example embodiment of the claimed invention can also include a portable electronic step-by-step computing device where the step-by-step instruction manual is stored in a database in the portable electronic step-by-step computing device. Instructions for storing a step-by-step instruction manual can include instructions for identifying title and step data associated with the step-by-step instruction manual, instructions for creating a main table of the title and step data including a step-by-step ID, a name, and a date on which the step-by-step instruction manual was stored, instructions for creating a steps table including step text, guide ID, and step number data, and the step ID, and instructions for creating a local path table that includes local paths to attachment files used within a step. In one example embodiment, instructions for indexing the title and step data associated with the step-by-step instruction manual in a local app database in the portable electronic step-by-step computing device are also provided.

One example embodiment of the claimed invention can also include a portable electronic step-by-step computing device, where one or more programs further include instructions for displaying a roadmap block on the touch screen display. The roadmap block can include a title block and a step 1 block.

Additionally, one example embodiment of the claimed invention can include a portable electronic step-by-step computing device, where one or more programs further include instructions for displaying an additional step screen page template on the touch screen display, where the additional step screen page includes an additional step block and an additional attachment block and instructions for detecting an entered additional step in the additional step block and an additional finger tap gesture at a location on the displayed step screen page template. The programs of the portable electronic step-by-step computing device can further include instructions for updating a displayed roadmap block on the touch screen display, where the roadmap block includes a title block and a step 1 block.

### BRIEF DESCRIPTION OF THE DRAWINGS

FIG. 1 illustrates one example system for creating a step-by-step instructional guide in accordance with the claimed invention.

FIG. 2 shows an example computing device used in a system for creating step-by-step instructional guides in accordance with the claimed invention.

FIG. 3 is a process flow diagram for creating a new step-by-step instructional guide in accordance with the claimed invention.

FIGS. 4A-4R are screen shots of user interface screens generated by the claimed invention when creating a new step-by-step instructional guide according to a method of the claimed invention.

FIG. 5A is a process flow diagram for editing a step-by-step instructional guide in accordance with the claimed invention.

FIG. 5B is a process flow diagram showing options for deleting, viewing, and editing a saved step-by-step instructional guide in accordance with the claimed invention.

FIG. 5C is a process flow diagram for sharing a step-by-step instructional guide in accordance with the claimed invention.

FIGS. 6A-6D are screen shots of user interface screens generated by the claimed invention when editing a step-by-step instructional guide according to a method of the claimed invention.

FIGS. 7A-7B are screen shots of user interface screens generated by the claimed invention when saving a step-by-step instructional guide according to a method of the claimed invention.

FIGS. 7C-7E are screen shots of user interface screens generated by the claimed invention when viewing a step-by-step instructional guide according to a method of the claimed invention.

FIG. 7F is a screen shot of a user interface screen generated by the claimed invention when sharing a step-by-step instructional guide according to a method of the claimed invention.

### DETAILED DESCRIPTION

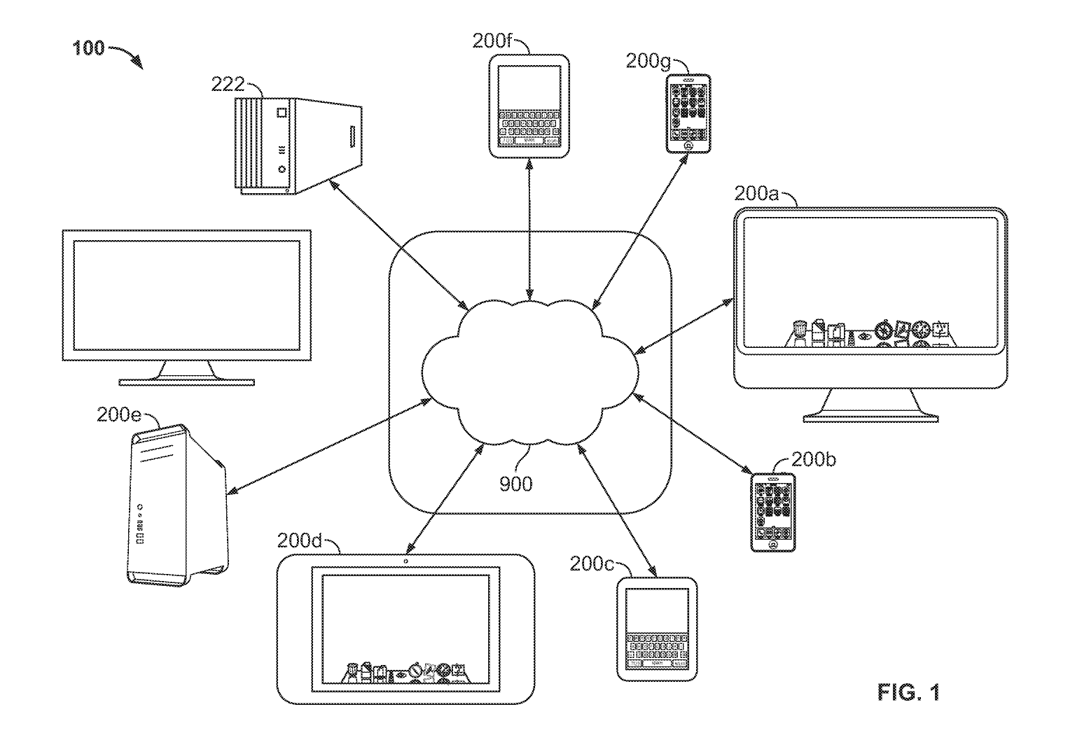

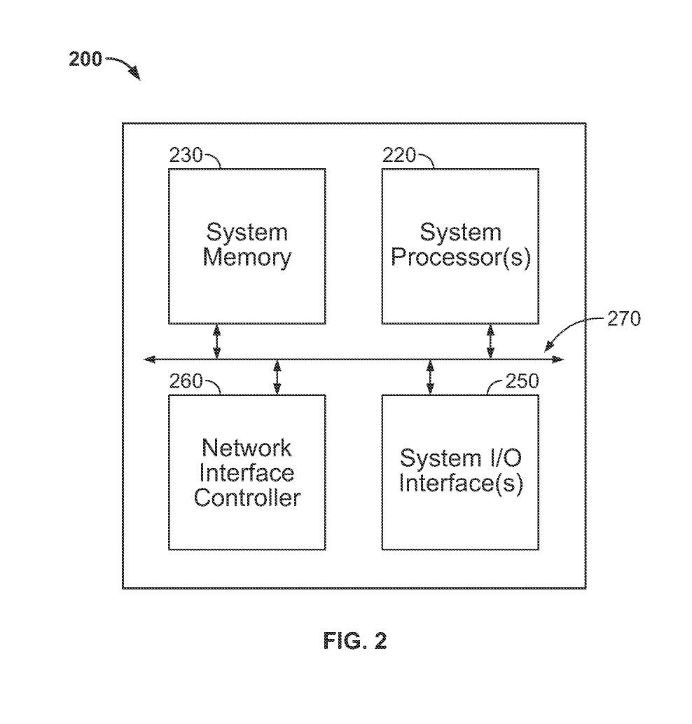

One example embodiment of the claimed invention includes a system for creating a step-by-step instructional guide. For example, FIG. 1 includes a number of exemplary computing devices 200, including laptop computer 200d, desktop computers 200a, 200e, and mobile computing devices 200b, 200c, 200f, 200g. For brevity and clarity, in FIG. 1, seven computing devices 200a-200g are shown connected through an exemplary network 900, but it should be understood that any number and type of computing devices can be employed in the exemplary system 100. For example, the computing device can also be a tablet computer, a smart phone, and the like. Likewise, a single computing device 200 is shown in FIG. 2, but any number of computing devices can also use the exemplary network 100 as well. The network 900 can be any collection of computers and other computing devices interconnected by communication channels sharing resources and information. For example, computer network 900 can be a local area network, a wide area network, an intranet, an extranet, the Internet, and the like. In the examples discussed, computing devices are referred to by reference numeral 200 and include an integrated application operative to communicate with distinct servers (for example, server 222 in FIG. 2) associated with providing the step-by-step instruction manual templates. As another example, the computing device can connect with distinct servers associated with actions, text, videos, audio files, and the like that can be used in creating a step-by-step instruction manual.

### Computing System

FIG. 2 shows the client computers, handheld devices, and/or server computers (“computing devices”) described in these examples as reference numerals 200a-200g. The server that provides the step-by-step instruction templates is shown as server 222 in FIG. 2. The computing devices 200 provide an application operative to communicate with the step-by-step provider server 222 in accordance with the claimed invention. The computing devices 200 include system processor(s) 220, system memory 230, system I/O interface(s) 250, and network interface controller 260, which are connected together by a bus 270 or by other numbers and types of links, although the computing devices 200 can include other components and elements in other configurations.

In this example embodiment, the computing device 200 is implemented as a standalone device, although the computing device 200 can be implemented as a blade device in a chassis-blade implementation, for example, as well as in an array of computers, such as in a parallel computing environment, for example. These computing devices can be programmed using the method of the claimed invention described below to create, save, review, edit, and distribute (i.e., share) the step-by-step instruction application.

System processor 220 includes one or more microprocessors configured to execute computer/machine readable and executable instructions stored in system memory 230 to create, review, edit, and distribute the step-by-step instruction application. System processor includes editing and control modules (not shown separately in FIG. 2) that perform editing and control operations when a user reviews and/or publishes a step-by-step instruction guide. When executed by at least one processor, the instructions stored in system memory 230 cause the processor 220 to carry out the claimed method described herein and illustrated on the associated flow chart to create a new step-by-step set of instructions, review the instructions, edit and revise the instructions, save the instructions, and distribute the application.

The instructions on the computer readable medium, including system memory 230, further cause the processor 220 to perform the above described steps of the claimed method to create, save, review, edit, and distribute the step-by-step instruction application.

The system processor 220 is configured to execute computer/machine readable and executable instructions stored in system memory 230 to implement one or more portions of the processes described further below in connection with FIG. 2, for example, although processor 220 can include other types and/or combinations of processors, such as digital signal processors, micro-controllers, switch chips, bus controllers, application specific integrated circuits (“ASICs”), programmable logic devices (“PLDs”), field programmable logic devices (“FPLDs”), field programmable gate arrays (“FPGAs”), and the like, programmed or configured according to the methods and processes as described and illustrated herein with respect to FIG. 2. System processor 220 can also include control circuitry to control the operations and performance of the computing device 200. For example, system processor 220 can be used to run operating system applications, firmware applications, media playback application, media editing operations, and the like. In some example embodiments of the claimed invention, system processor 220 can drive a display and process inputs received from a user interface or system I/O interfaces (described below).

System memory 230 includes computer readable media, namely computer readable or processor readable storage media, which are examples of machine-readable storage media. Computer readable storage/machine-readable storage media can include volatile, nonvolatile, removable, and non-removable media implemented in any method or technology for storage of information, such as computer readable/machine-executable instructions, data structures, program modules, or other data, which can be obtained and/or executed by one or more processors, such as system processor 220, to perform actions, including implementing an operating system for controlling the operation of computing device 200 to perform the described steps of the claimed method to create, save, review, edit, and distribute the Step-by-Step instruction application in accordance with the processes described above and in connection with FIG. 2, for example. System memory 230 can also be used to store data used to operate computing device applications as well. Additionally, system memory 230 can include storage media for storing media data, application data, firmware, user preference information, authentication information, lifestyle information data, transaction information data, communication connection information data, subscription information data, contact information data, calendar information data, and any other suitable data and combinations of data.

Examples of computer readable storage media include RAM, BIOS, ROM, EEPROM, flash/firmware memory or other memory technology, CD-ROM, digital versatile disks (DVD) or other optical storage, magnetic cassettes, magnetic tape, magnetic disk storage or other magnetic storage devices, or any other medium which can be used to store the desired information, including data and/or computer executable instructions or other machine-executable instructions, and which can be accessed by a computing device or a specially programmed device, such as computing device 200. When the instructions stored in system memory 230 are run by the system processor 220, the computing device 200 implements at least a portion of the processes described below to perform the steps of the claimed method to create, save, review, edit, and distribute the step-by-step instruction application.

System I/O interface(s) 250 includes one or more user input and output device interface mechanisms, such as a computer keyboard, mouse, display device, and the corresponding physical ports and underlying supporting hardware and software to enable the computing device 200 to communicate with other devices for accepting user data input and to provide user output, although other types and numbers of user input and output devices can be used. I/O interface 250 can operate to convert, encode, and decode analog signals and other signals into digital data. In one example embodiment, I/O interface 250 can also convert digital data into any other type of signal, and vice-versa. For example, I/O interface 250 can receive and convert physical contact inputs (e.g., from a multi-touch screen), physical movements (e.g., from a mouse or sensor), analog audio signals (e.g., from a microphone), or any other input. The digital data can be provided to and received from the system processor 220, system memory 230, or any other component of computing device 200. Although I/O interface 250 is illustrated in FIG. 2 as a single component of computing device 200, multiple system I/O interfaces 250 can be included in computing device 200.

Alternatively, or in addition, as will be described in connection with network interface controller 260 below, the computing device 200 can communicate with other devices on the network for certain types of operations (e.g., configuration, data transfer, and the like) via a network management port, for example.

Network interface controller 260 provides physical access to a networking medium and provides a low level addressing system, which enables the computing device 200 to engage in TCP/IP communications over a network system (not shown separately) and to perform the described steps of the claimed method to create, save, review, edit, and distribute the step-by-step instruction application although the network interface controller 260 can be constructed for use with other communication protocols and types of networks, and can include other components, and can perform other functions. Network interface controller 260 is sometimes referred to as a transceiver, transceiving device, or network interface card (NIC), which transmits and receives network data packets to one or more networks, such as network 900 or other network systems. When the computing device 200 includes more than one system processor 220 (or processor 220 has more than one core), each processor 220 (and/or core) can use the same single network interface controller 260 or a plurality of network interface controllers 260. Further, the network interface controller 260 can include one or more physical ports, such as Ethernet ports, to couple the computing device 200 with other network devices, such as servers, handheld devices, other computing devices, and other sites. Additionally, the network interface controller 260 can include certain physical ports dedicated to receiving and/or transmitting certain types of network data, such as device management related data for configuring the computing device 200.

In one example, the network interface controller 260 is an FPGA that can include a local memory and be configured with logic to implement one or more aspects of the technology, including by way of example only, performing the below described steps of the claimed method to create, save, review, edit, and distribute the step-by-step instruction application, although the network interface controller 260 can include other types of configurable hardware, such as digital signal processors, micro-controllers, ASICs, PLDs, FPLDs, and the like, programmed or configured according to the teachings as described and illustrated herein with respect to FIG. 2, as well as software executed by the system processor 220, combinations thereof, and other components and elements configured in other manners that implement one or more aspects of the claimed invention. The use of specialized hardware in this example allows the network interface controller 260 to rapidly process network data packets.

Network interface controller 260 can include communications circuitry that connects computing device 200 to other devices in a communications network, such as network 900 shown in FIG. 1. Network interface controller 260 can use any suitable communications protocol such as, for example, Wi-Fi (e.g., a 802.11 protocol), Bluetooth®, radio frequency systems (e.g., 900 MHz, 1.4 GHz, and 5.6 GHz communication systems), infrared, GSM, GSM plus EDGE, CDMA, quadband, and other cellular protocols, VOIP, or any other suitable protocol.

Bus 270 includes at least one internal device component communication bus, link, bridge and supporting components, such as bus controllers and/or arbiters. These devices enable the various components of the computing device 200, such as the system processor 220, system memory 230, system I/O interface 250, and network interface controller 260, to communicate, although the bus 270 can enable one or more components of the computing device 200 to communicate with other components.

While each of the computing devices can include the processor 220, memory 230, network interface controller 260, and I/O interface 250 coupled together by a bus 270, two or more computing systems or devices can be substituted for any one of the devices in the system 100 shown in FIG. 1. Accordingly, principles and advantages of distributed processing, such as redundancy, replication, and the like, also can be implemented as desired to increase the robustness and performance of the devices of the system 100. The system 100 can also be implemented on a computer system or systems that extend across any network environment using any suitable interface mechanisms and communications technologies including, for example telecommunications in any suitable form (e.g., voice, modem, and the like), Public Switched Telephone Network (PSTNs), Packet Data Networks (PDNs), the Internet, intranets, a combination thereof, and the like.

As outlined above, each of the computing devices can include a central processing unit (CPU), controller or processor, a memory, and an interface system which are coupled together by a bus or other link, although other numbers and types of each of the components and other configurations and locations for the components can be used. The processors in the computing devices can execute a program of stored instructions for one or more aspects of the methods and systems as described herein, although the processor could execute other types of programmed instructions. The memory can store these programmed instructions for one or more aspects of the methods and systems as described herein, although some or all of the programmed instructions could be stored and/or executed elsewhere. A variety of different types of memory storage devices, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to the processor, can be used for the memory. The user input device can include a computer keyboard and a computer mouse, although other types and numbers of user input devices can be used. The display can include a computer display screen, such as a CRT or LCD screen or touch screen by way of example only, although other types and numbers of displays could be used.

Although an example of the computing devices is described and illustrated in connection with FIG. 2, the computing devices 200a-200g of the system 100 could be implemented on any suitable computer system or computing device. It is to be understood that the example devices and systems of the system 100 are for exemplary purposes, as many variations of the specific hardware and software used to implement the system 100 are possible, as will be appreciated by those skilled in the relevant art(s).

Further, each of the devices of the system 100 can be conveniently implemented using one or more general purpose computer systems, microprocessors, digital signal processors, micro-controllers, application specific integrated circuits (ASIC), programmable logic devices (PLD), field programmable logic devices (FPLD), field programmable gate arrays (FPGA) and the like, programmed according to the methods and processes described and illustrated herein, as will be appreciated by those skilled in the computer, software, and networking arts.

The operation of example processes and methods to perform the below described steps of the claimed methods to create, save, review, edit, and distribute the step-by-step instruction application can be run on a networked system. The flow diagrams are representative of example machine readable instructions for creating, saving, reviewing, editing, and distributing the step-by-step instruction application and operating the step-by-step computing device.

The steps described are example machine readable instructions for implementing methods of the examples described in this disclosure. In one example, the machine readable instructions include an algorithm for execution by a processor, a controller, and/or one or more other suitable processing device(s). The algorithm can be instantiated in software stored on tangible media such as, for example, a flash memory, a CD-ROM, a floppy disk, a hard drive, a digital video (versatile) disk (DVD), or other memory devices, but persons of ordinary skill in the art will readily appreciate that the entire algorithm and/or parts thereof could alternatively be executed by a device other than a processor and/or embodied in firmware or in dedicated hardware.

For example, the algorithms can be implemented by an application specific integrated circuit (ASIC), a programmable logic device (PLD), a field programmable logic device (FPLD), a field programmable gate array (FPGA), discrete logic, etc.). For example, any or all of the components of the system could be implemented by software, hardware, and/or firmware. Further, although an example of the present invention is described and illustrated herein, persons of ordinary skill in the art will readily appreciate that many other methods of implementing the example machine readable instructions can alternatively be used. For example, the order of execution can be changed, and/or some of the steps described can be changed, eliminated, or combined.

With this computing device configuration, through an integrated step-by-step application, the user can access the step-by-step instruction manual provider and create and customize a step-by-step manual. This system configuration and the method described below provide an inviting interaction for users to learn, operate, and perform a wide variety of tasks. Step-by-step instructions can be created, edited, and distributed to other users to provide explanations and information of interest using an interactive template in accordance with the claimed invention.

Launching the Step-by-Step app

Through the integrated step-by-step application, a user can securely connect to one or more servers associated with a provider of the step-by-step application. For example, the computing device 200 can connect with distinct servers (such as server 222) associated with providing the step-by-step instruction manual templates. Processor 220 of computing device 200 accesses the application provider, such as server 222 and requests the step-by-step instruction manual application. The step-by-step instruction manual application can be available to purchase or free of charge. After any necessary payment steps, the computing device 200 receives the step-by-step instruction manual template application via a download from server 222 and stores the application in a database in memory 230. The step-by-step instruction manual template application can be a disk image file (.dmg) or other executable file. An installation framework, such as a library file that controls how applications are securely installed on the computing device 200, can manage execution of the application, including launching the application. Once the step-by-step application is installed in the user computing device 200, the application immediately allows the user to execute the step-by-step application to begin creating their step-by-step instruction manual.

As another example, the computing device can connect with a distinct server 222 associated with actions, text, videos, audio files, and the like that can be used in creating a step-by-step instruction manual. Once a user connects to the application provider server 222, an icon can be stored on the computing device 200 from which the step-by-step instruction guide application can be launched or otherwise initiated.

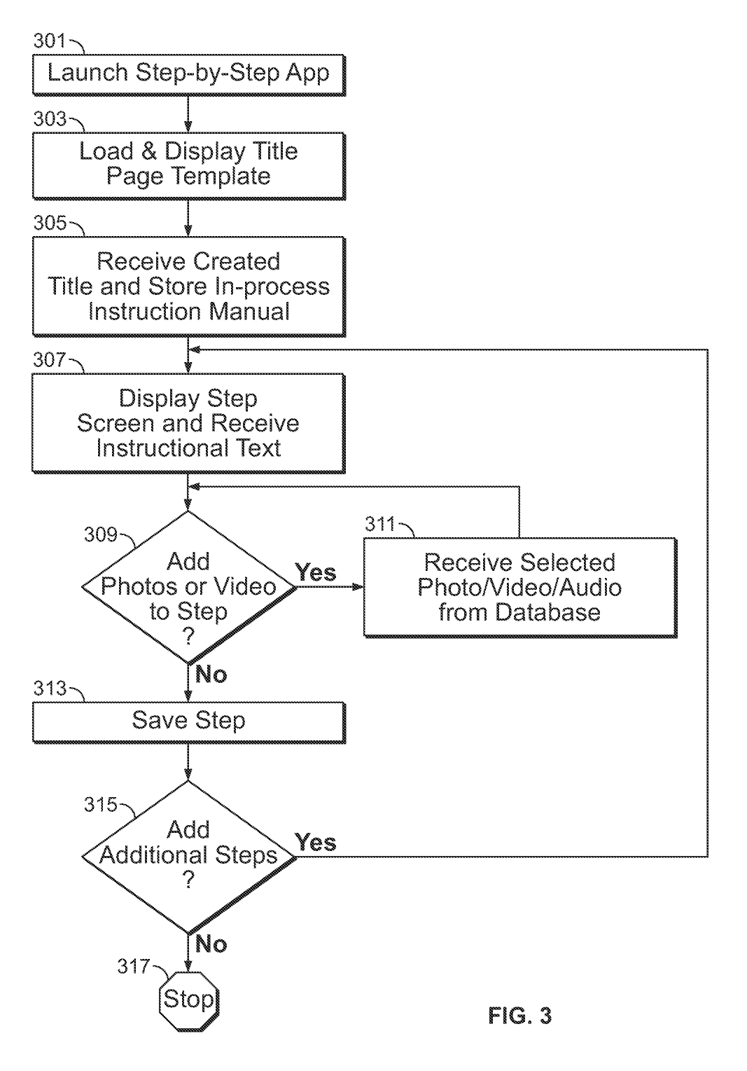

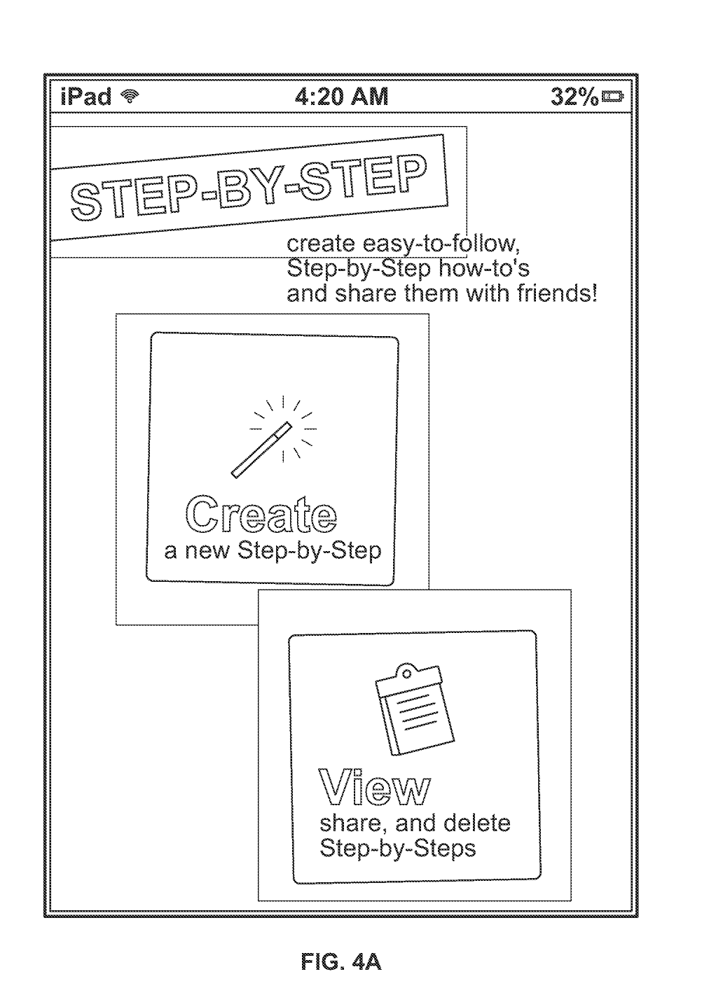

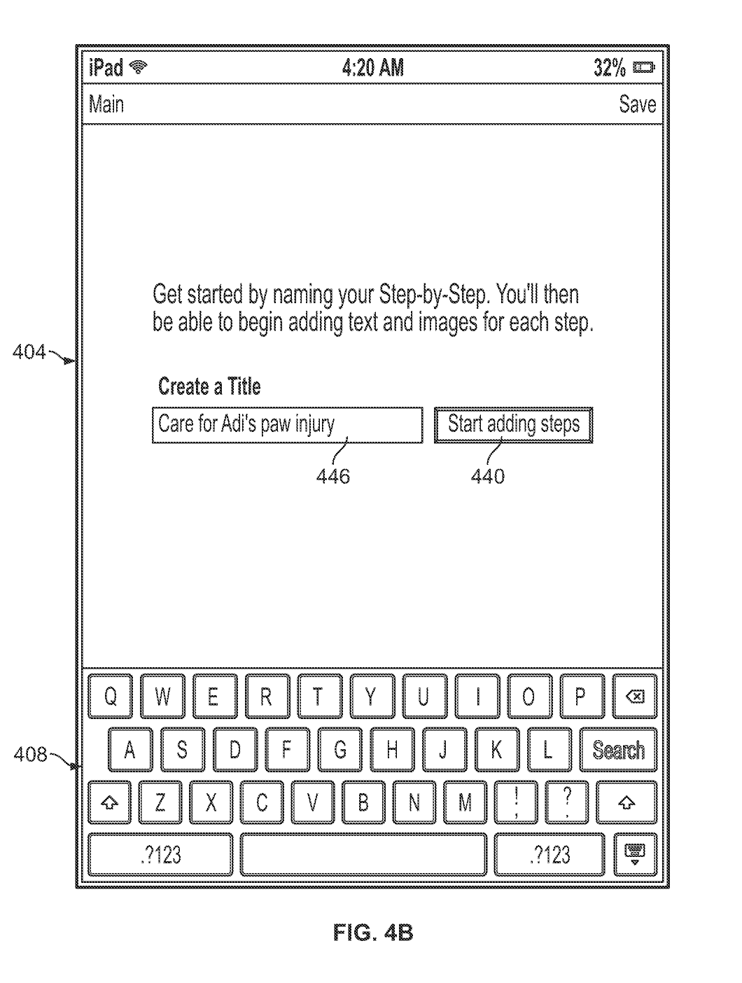

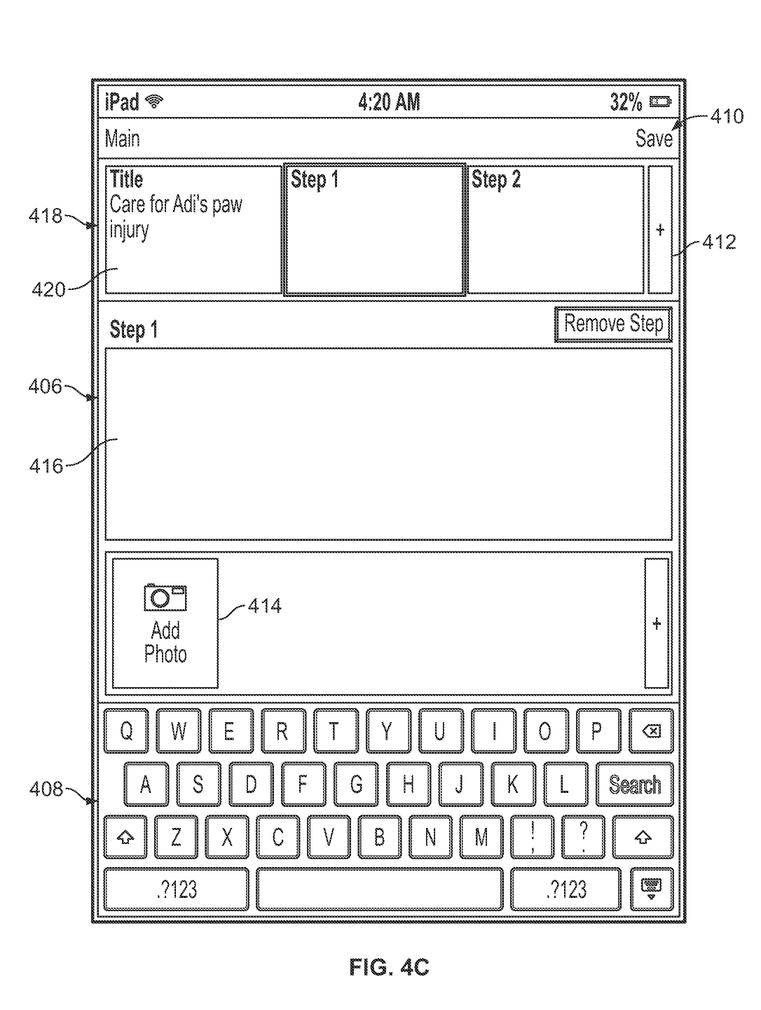

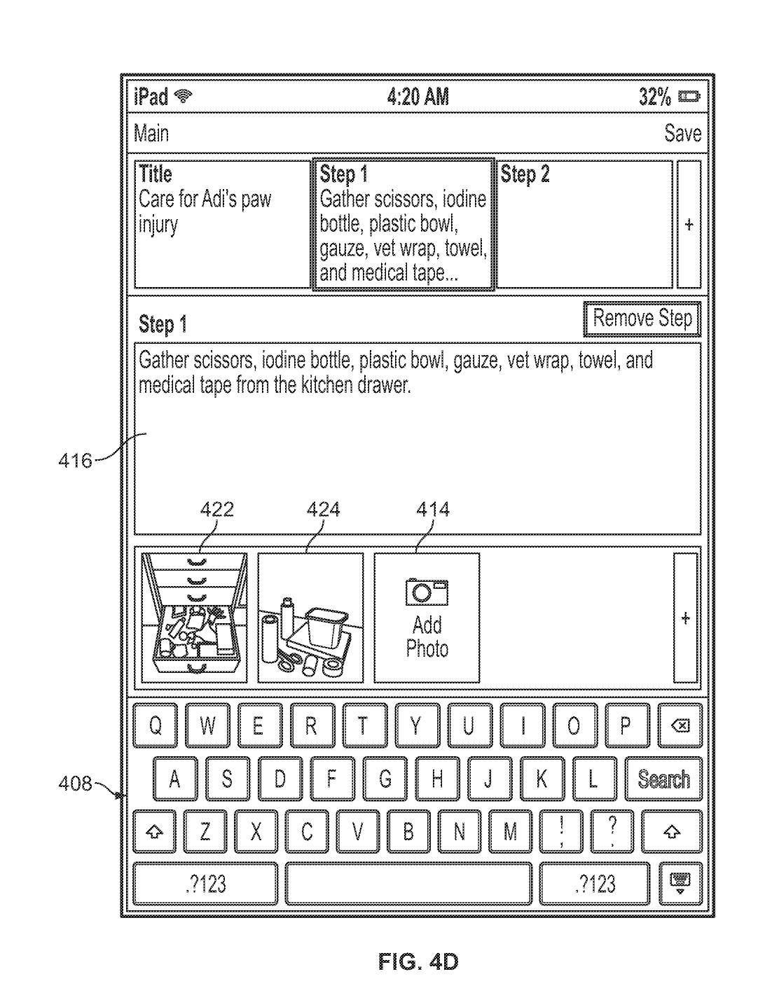

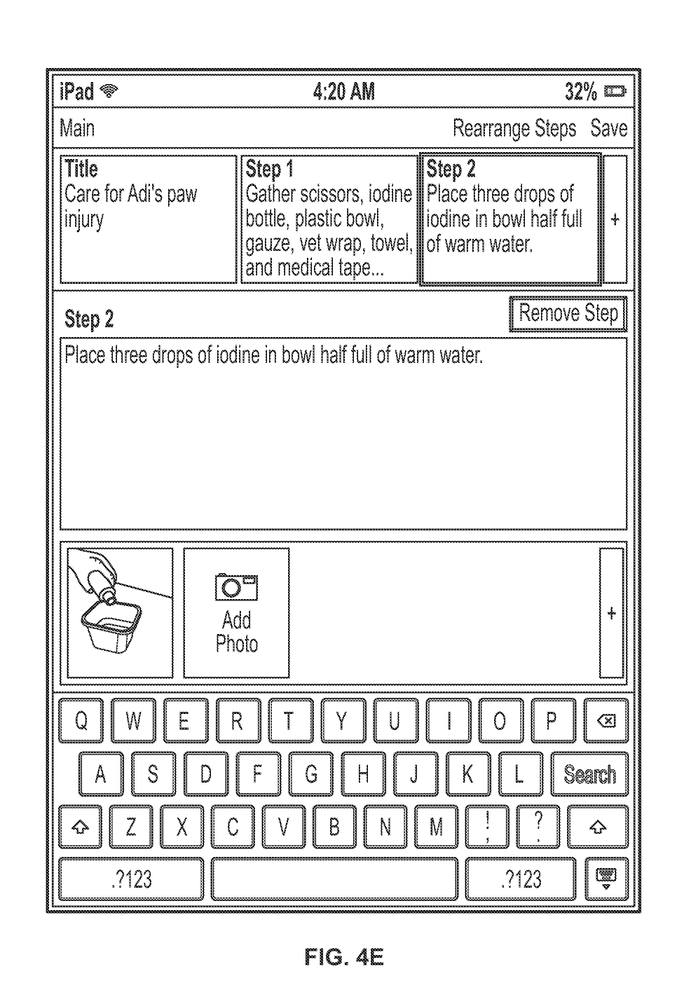

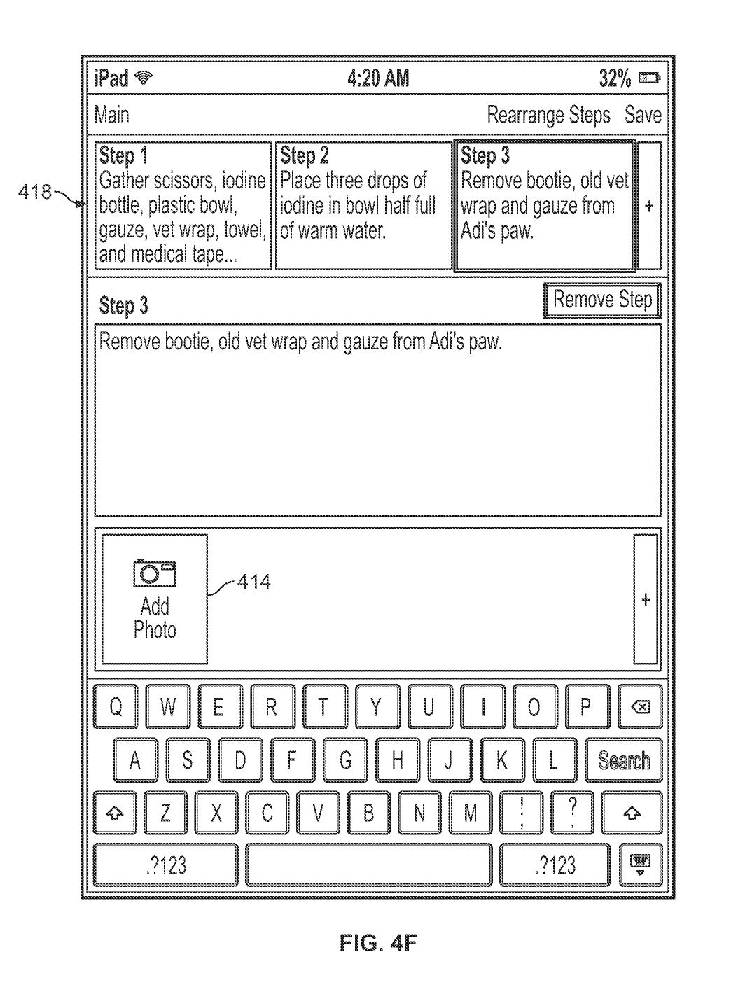

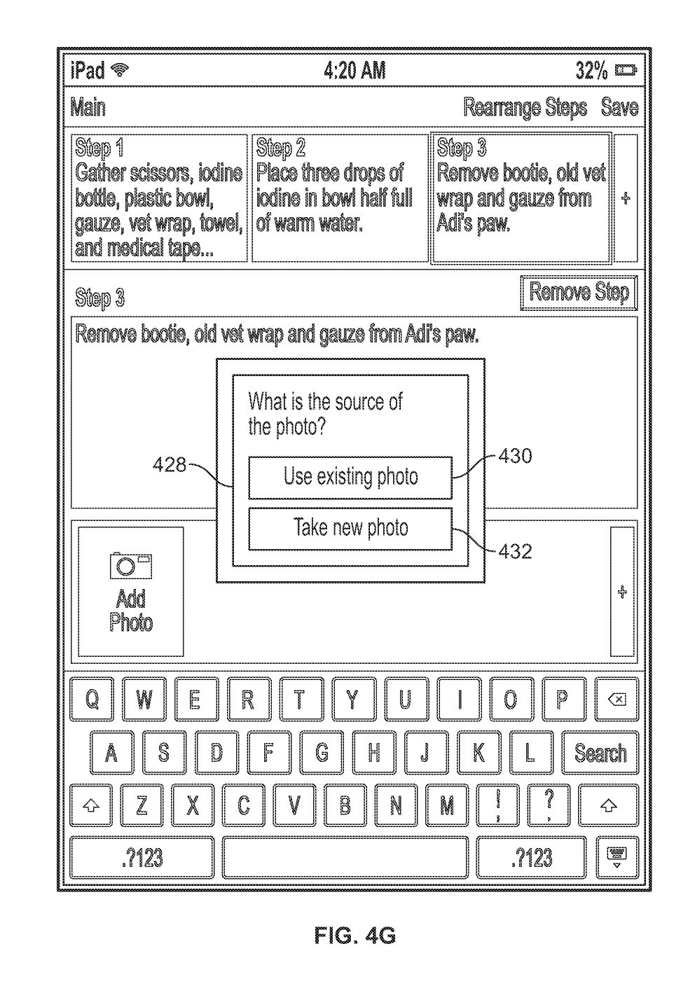

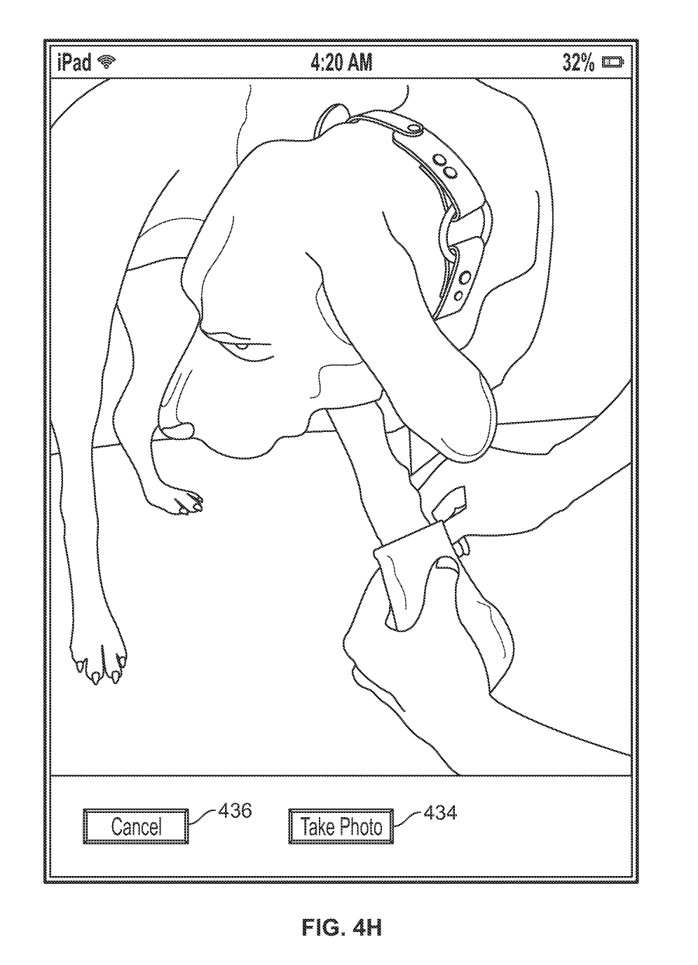

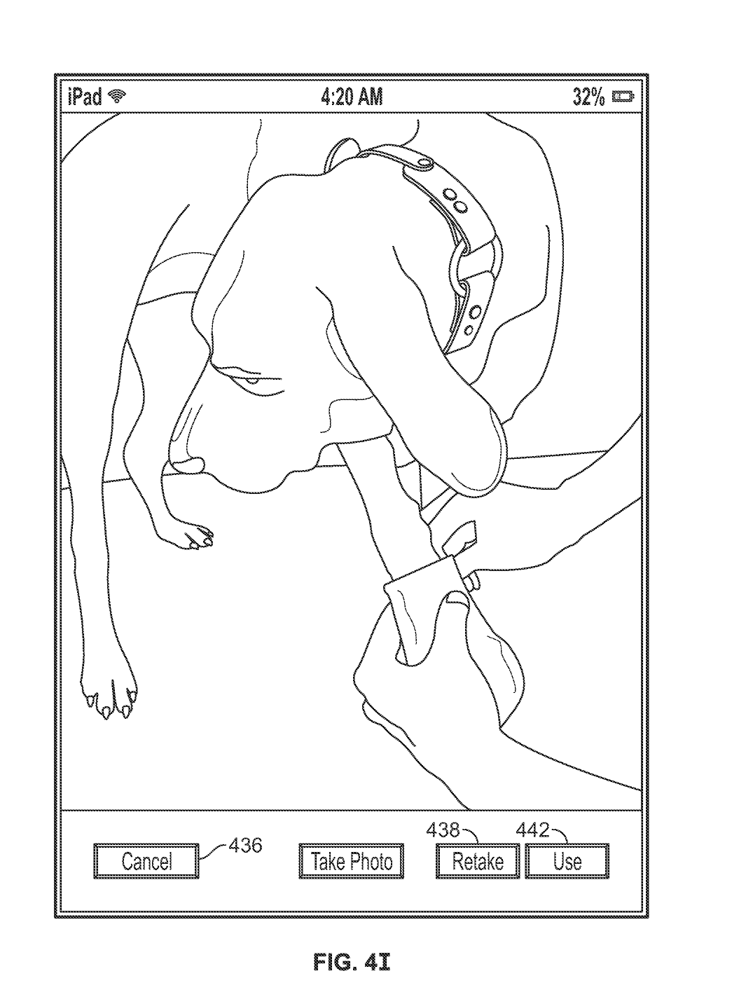

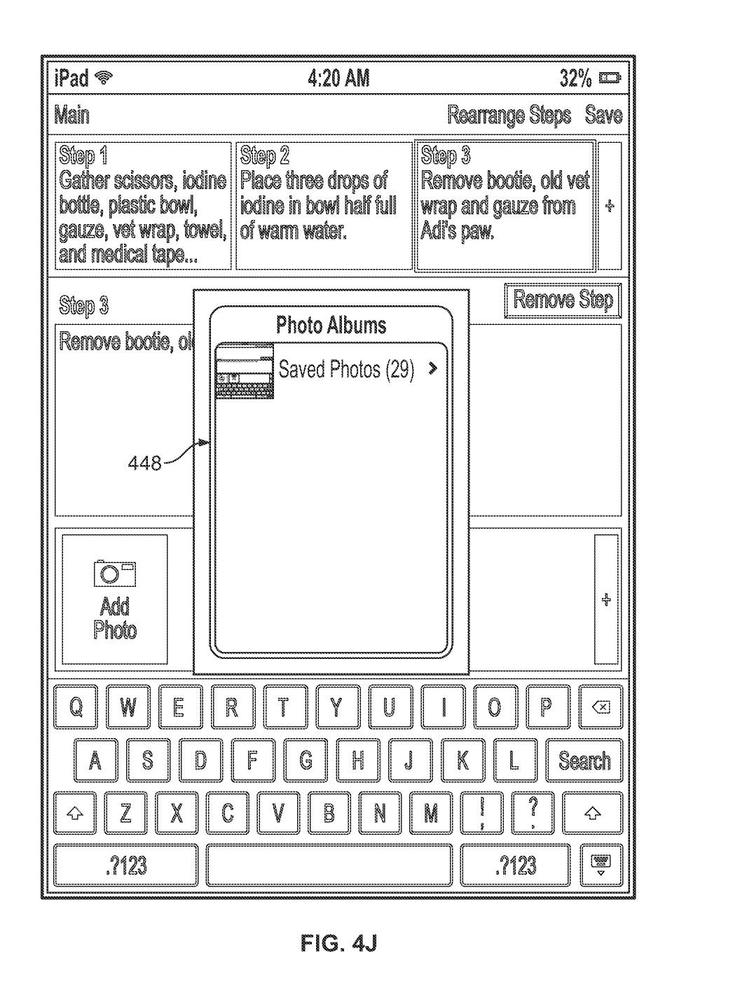

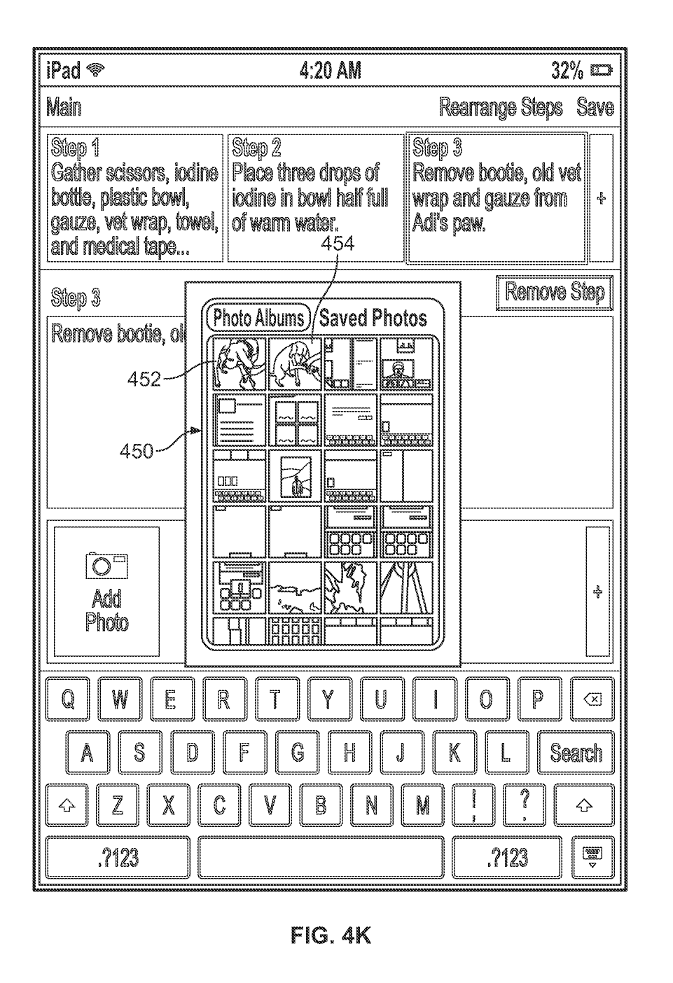

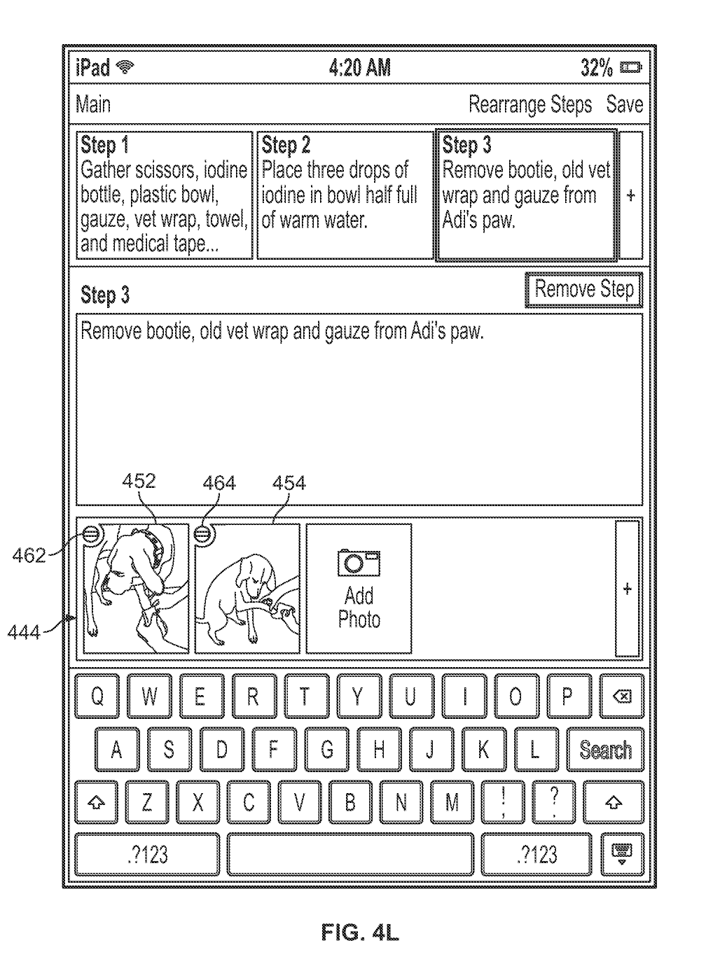

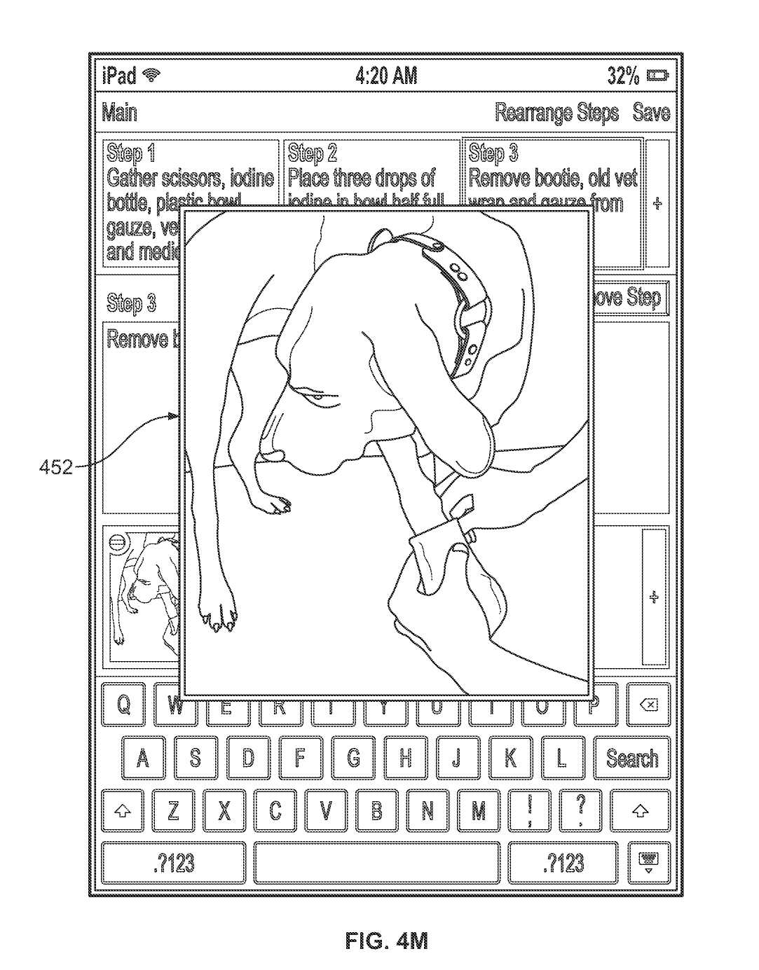

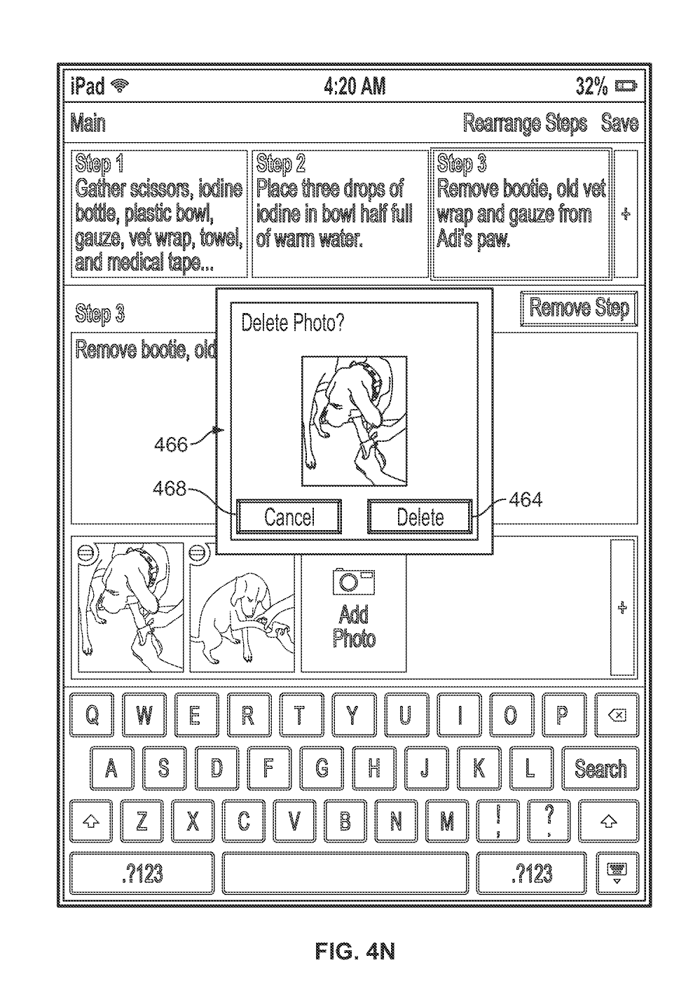

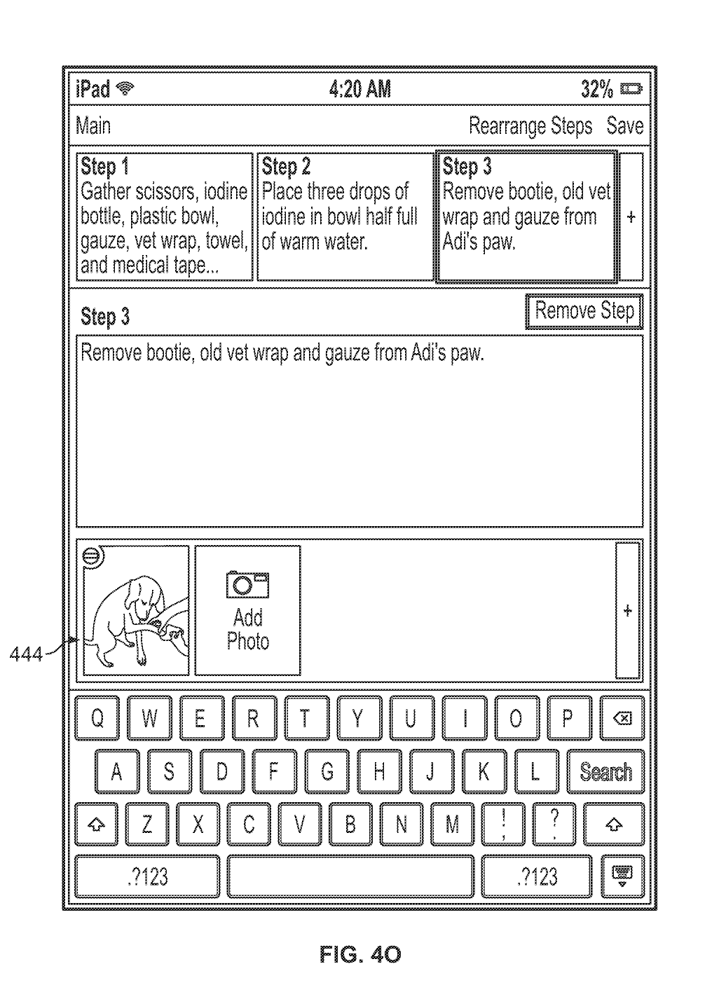

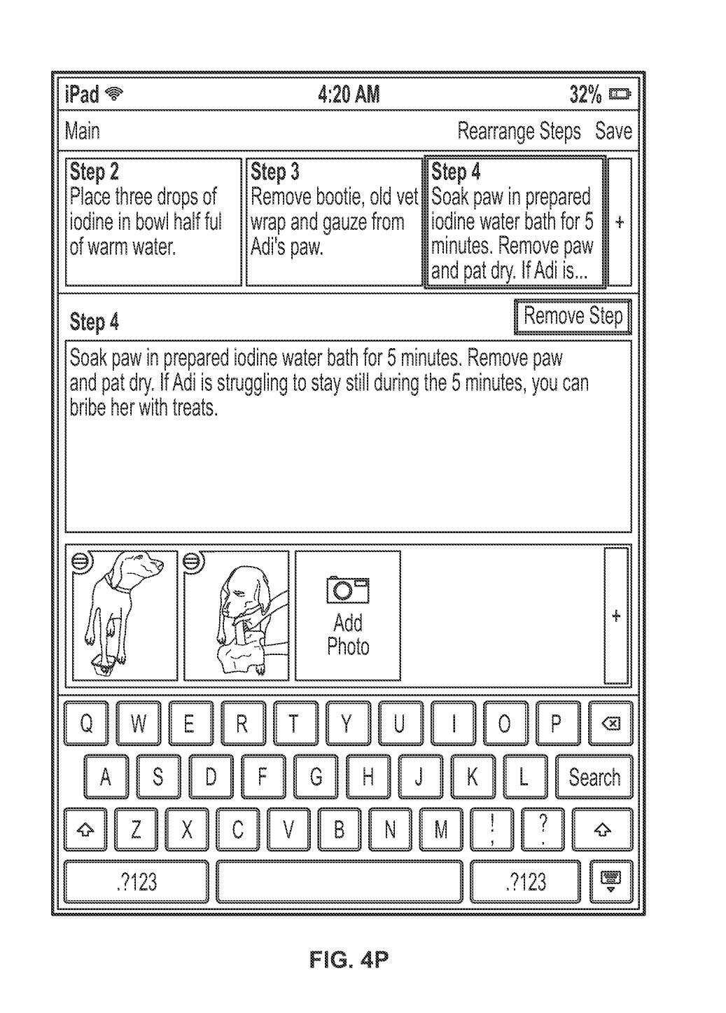

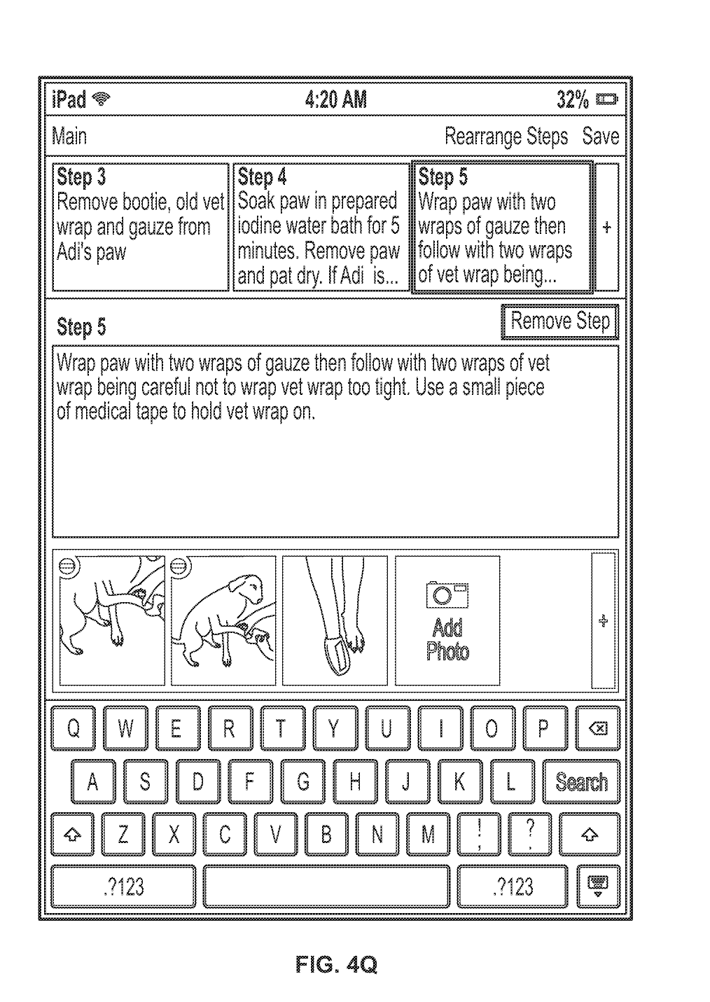

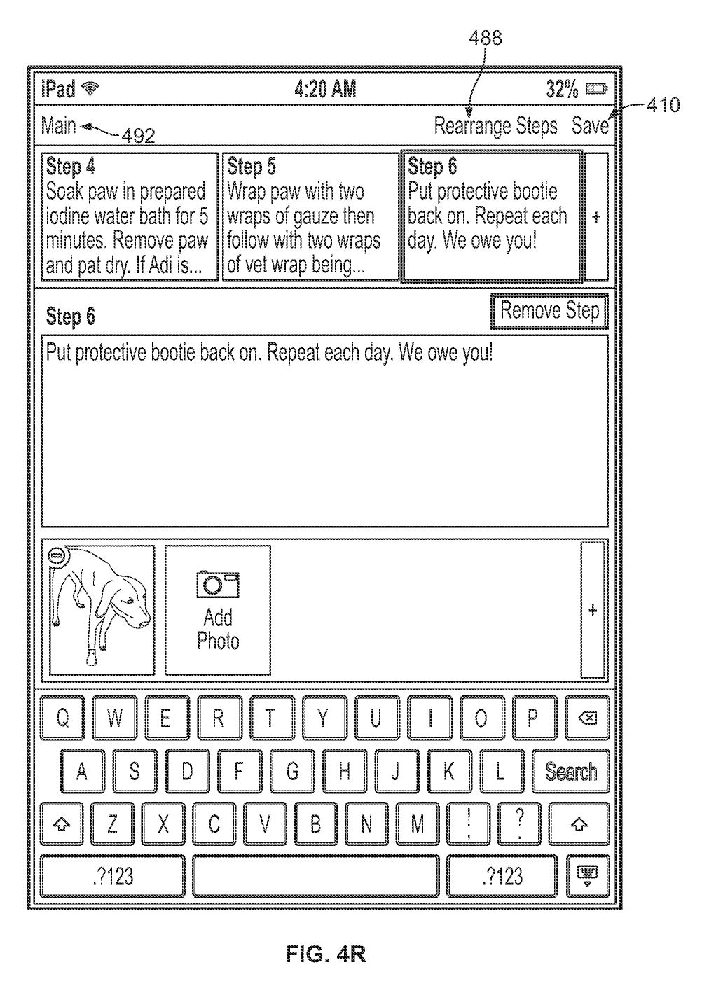

As shown in FIG. 3, when a user selects and launches the step-by-step instruction guide application in block 301 from computing device 200, a splash screen FIG. 4A is displayed on a display of the computing device 200.

Creating a New Step-by-Step Instruction Manual

Once the step-by-step instruction guide application is installed in computing device 200, a user can perform an example embodiment of the claimed invention of a method of creating a new step-by-step instruction manual. Creating a new step-by-step instruction manual is performed through a main menu on the user's computing device 200. As shown in block 303 and in FIG. 4B, a title page template 404 is loaded from the memory 230 of the computing device 200, and processor 220 displays the title page template 404 on the display of the computing device 200. In block 305, a user enters a title for the step-by-step instruction manual in title space 446 using keypad 408. Once the user names the step-by-step instruction manual, the user selects the “start adding steps” button 440, and the creation of the in-process step-by-step instruction manual is initiated as the processor 220 stores the in-process manual in a database in memory 230 based upon its title. The data associated with the created steps is stored locally in a database in memory 230 of the user's computing device 200. Steps can be temporarily stored until the user saves the in-process step-by-step instruction manual to the database.

In block 307 of FIG. 3, the Step 1 screen 406 is displayed by the processor 220 on the computing device 200 as further shown in FIG. 4C. The Step 1 screen 406 includes a roadmap block 418 at the top of the display showing at which step in the creation of the step-by-step manual the user is currently viewing. For example, in FIG. 4C, a user has named the step-by-step manual “Care for Adi's paw injury” as shown in the title block 420 of the roadmap block 418. A plus button 412 can be selected by the user to advance further along in the roadmap, while a minus button (not shown in FIG. 4C) can be selected to move back in the roadmap. A save button 410 is also shown, and a user can save the in-process step-by-step manual by selecting the save button 410, whereupon the processor 220 saves the in-process manual to the database in memory 230 with any updates that have been performed since the manual was last saved. When creating a step-by-step manual, a user can enter instructional text in the Step 1 block 416 using keypad 408. As described below, users can also add photos or other video images using add photo button 414 to complement the entered text as described below.

FIG. 4D shows instructional text entered in the Step 1 block 416 using the keyboard 408. In block 309 of FIG. 3, the user can determine if they would like to add photos, video images, or audio to Step 1 to complement the entered text. If the user does not wish to add photos, video images, or audio to Step 1, the process continues to block 313. If the user wants to add photos, video images, and/or audio to Step 1, the user can select the add photo button 414. The processor 220 then accesses a database in memory 230 and displays a directory of photos, videos, and audio files. As explained in detail below, the user can then select one or more existing photos, videos, and audio files to be included with the Step 1 text, and the processor 220 receives the selected files from a database in block 311. For example, in FIG. 4D, the user has selected two photographs 422, 424 of the supplies (scissors, iodine bottle, plastic bowl, gauze, etc.) described in the Step 1 block 416. When a user selects video images or audio files to complement the Step 1 text, a representation of the video or audio files is shown in place of the photographs 422, 424. Alternatively, the user can choose to take or use a new photo, video, and/or audio file to be included with the Step 1 text. Adding existing photos and taking new photos to be used is discussed below with regard to FIGS. 4F-4K.

If the user wants to include additional photos, videos, and/or audio files, the process returns to block 309, and the user can select the add photo button 414 to select additional photos, videos, and/or audio files. Once the user is finished adding audio and visual components to the Step, the process continues to block 313.

In block 313, the user selects the save button 410, and the Step and the updated instruction manual is saved in the database in memory 230. Data associated with the stored step-by-step instruction manual is identified and indexed and otherwise associated to the database or other storage container in memory 230. For example, each application stored on the user's computing device 200 can have its own database or storage container that is a part of memory 230. Saving a step-by-step instruction manual can be done while creating a new one or while editing. When a user decides to save an in-process or completed manual, each step is stored in the local app database in memory 230. There are three tables used to facilitate storage. First, the main table includes a step-by-step ID, name and created/modified date. This ID is used to create a relationship between the Steps table (described below) that stores all steps associated with that particular instruction manual. Second, the Steps table includes every step from all guides and includes an associated Guide ID, a Step Number (within the associated guide and used for Steps order), a Step Text and a Step ID. A unique auto incrementing Step ID is used to create a relationship with the third table, which includes all local paths to the images used for and within that particular Step. When Saving, Editing, or Removing any part of an instruction manual, the unique IDs are used.

When a user selects the Save button 410, (which they can do at any time during the step-by-step creation and editing processes—not just at the last step) the user can be shown a dialogue box (not shown separately) that notifies the user that their step-by-step instruction guide has been saved. The user is not directed away from whatever screen they are viewing. Once the step-by-step instruction guide is saved to the database in memory 230, the process returns to the same screen from which the user saved the instruction guide. That is, the instruction manual is saved but the user is able to continue to work on the instruction manual.

After saving the step-by-step instruction manual, the process then continues to block 315 and the user determines if they would like to add additional steps. If the user does not wish to add additional steps, the process stops at block 317. If the user wants to add additional steps, the process returns to block 307, and the next step (Step 2) is created as shown in FIG. 4E.

In this fashion, the process continues, and the user adds one additional step at a time to continue creating the step-by-step instruction manual. As the user adds additional steps, the roadmap block 418 is updated as shown in FIG. 4F. As also shown in FIG. 4F, when a user chooses to add a photo, video, and/or audio file to be included with the text of the step, the user selects the add photo button 414.

As shown in FIG. 4G, selecting the add photo button 414 returns a dialog screen 428 with which the user can select an existing photo from the database in memory 230 or take a new photo with the computing device to be added to the Step to complement the text. In the same fashion, videos and/or audio files can also be selected or added to the Step. As outlined above, if the user wishes to add an existing photo, video, or audio file, the user can select that button 430 and access the file from a database in memory 230.

If the user would like to take a new photo (or take a new video or make a new audio recording), the user selects button 432 and the computing device 200 can be used to take a photo by selecting the take photo button 434 as shown in FIG. 4H. If the user changes their mind, they can select the cancel button 436 and return to the previous Step screen.

Once the user takes the photo, it will be displayed by the computing device 200 as shown in FIG. 4I. The user is then presented with the options of retaking the photo using button 438, using the photo by selecting button 442, or canceling and returning to the previous Step screen by selecting button 436. When using the photo by selecting button 442, the photo will be added to the photo block 444 as shown in FIG. 4L.

Alternatively, in FIG. 4G, when adding a photo, the user can choose button 430 from the dialog screen 428, and the user can select an existing photo from the database in memory 230. As mentioned above, videos and/or audio files can also be selected or added to the Step in a similar fashion. If the user would like to use an existing photo (or use an existing video or audio recording), the user selects button 430 and the computing device 200 displays a photo album directory 448 as shown in FIG. 4J. That is, the processor 220 accesses a database directory of photographs in memory 230 and provides a graphical display of the directory to the display of the computing device 200. While a single photo album directory 448 is shown in FIG. 4J, multiple photo album directories can be stored in the database in memory 230, and multiple photo album directories will be displayed from which the user can choose an existing photograph to include in the Step. Once the user selects the photo album directory from which they wish to select a photograph, the photo album contents 450 as shown in FIG. 4K will be displayed from which the user can select the individual photographs 452, 454 to be added to the Step screen.

When the user selects the individual photographs 452, 454, the photographs are added to the photo block 444 on the Step screen as shown in FIG. 4L. The user can review the selected photograph(s) by selecting the photographs 452, 454 from the photo block 444 on the Step screen, which will return a larger version of the photograph 452 as shown in FIG. 4M. If the user decides not to use a photograph from photo block 444 on the Step screen, the user can select one of the minus icons 462, 464 in FIG. 4L to delete the photograph(s) from the Step screen. For example, by selecting the minus icon 462, the delete photo dialog box 466 will be displayed as shown in FIG. 4N. The user can then decide to delete the photograph 452 by selecting the delete button 464 or to cancel the deletion by selecting the cancel button 466 in FIG. 4N. Upon deleting the photograph 452, the photo block 444 on the Step screen is updated as shown further in FIG. 40.

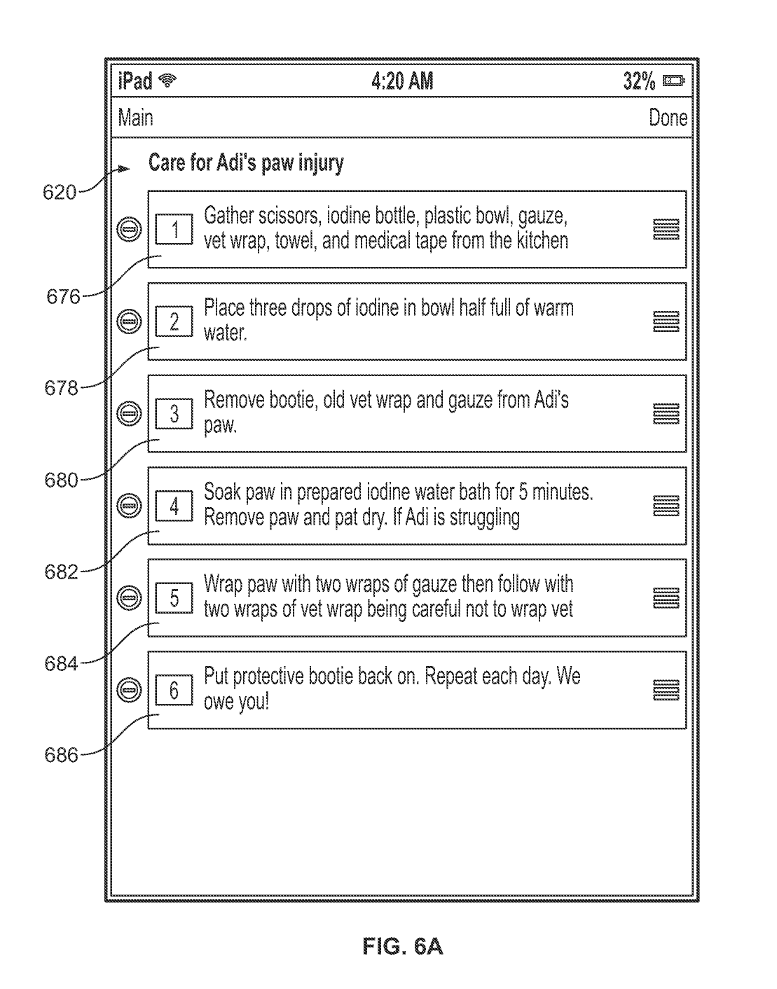

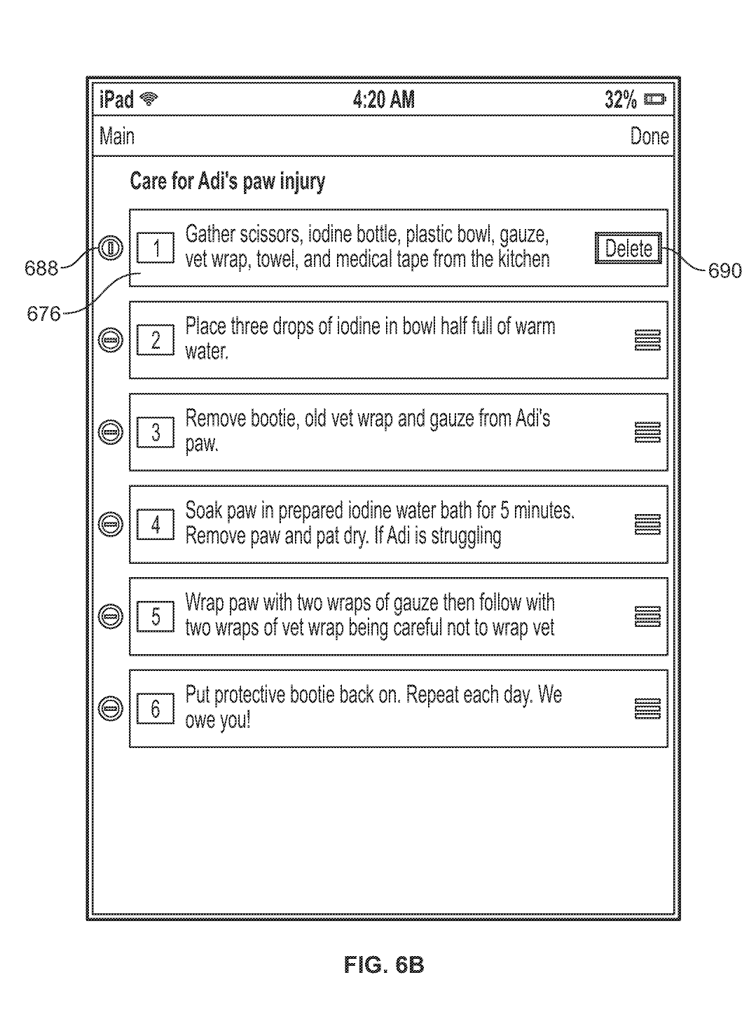

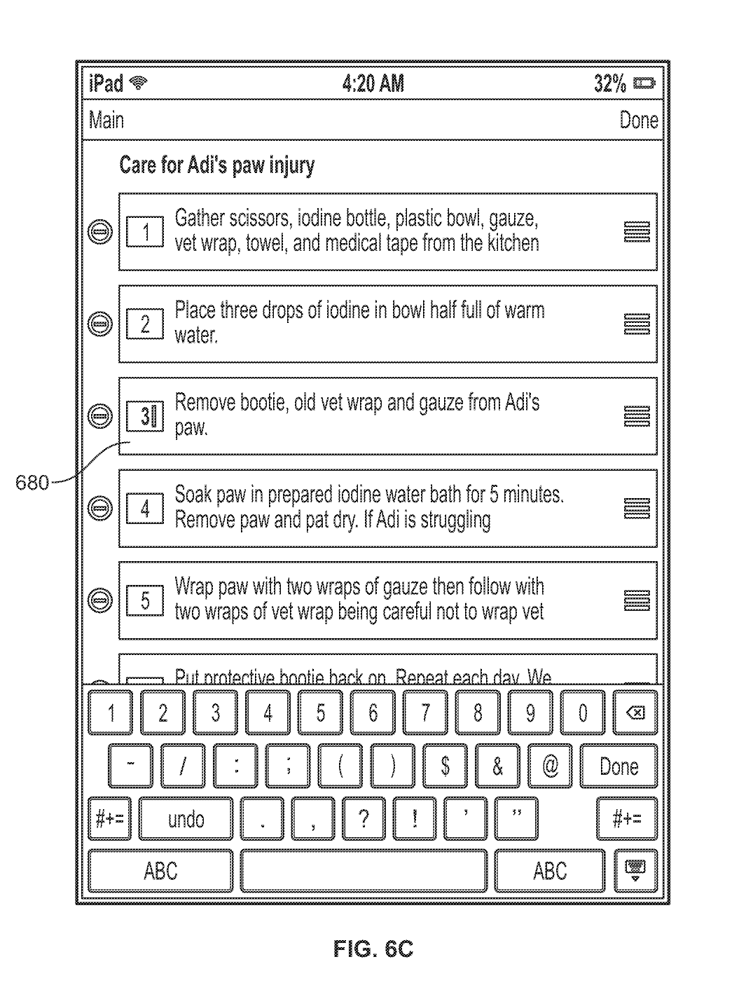

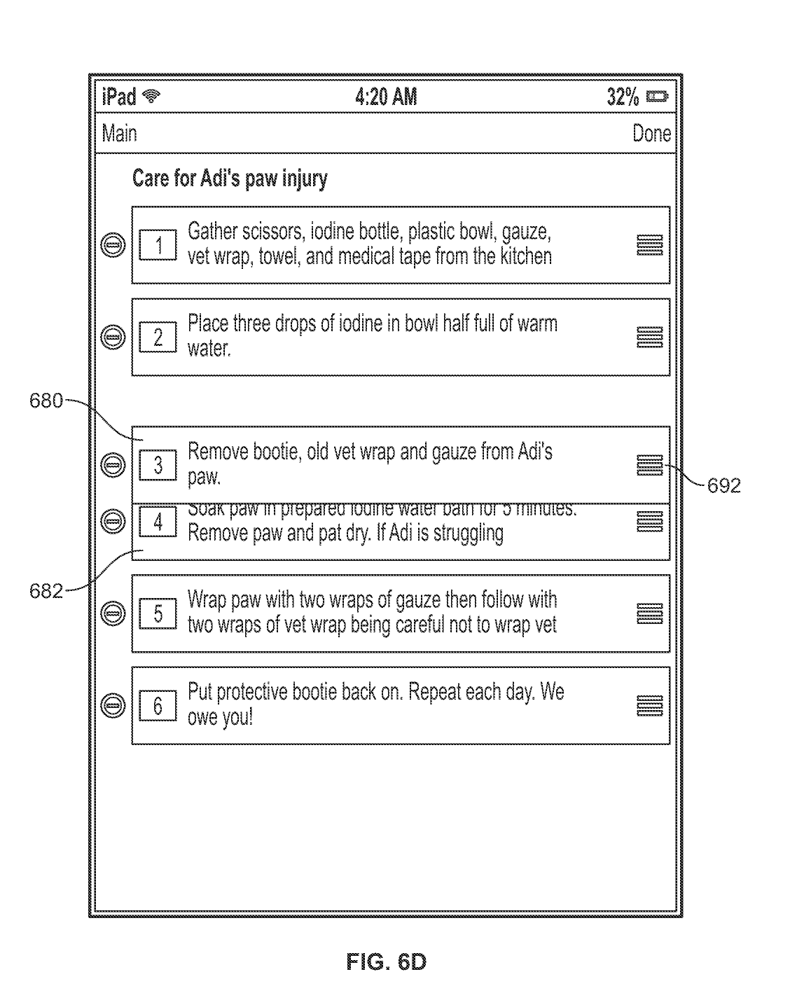

Additional Steps are added to the step-by-step instruction manual as shown in FIGS. 4P, 4Q, and 4R where Steps 4, 5, and 6 are added, respectively. Once the user has created Steps for the step-by-step instruction manual, the user can save the created Steps by selecting the Save button 410. As outlined above, when the user selects the Save button 410, the user can be shown a dialogue box (not shown separately) that notifies the user that their step-by-step instruction guide has been saved. The user is not directed away from whatever screen they are viewing. Once the step-by-step instruction guide is saved to the database in memory 230, the process returns to the same screen from which the user saved the instruction guide. In this case, the displayed screen shown in FIG. 4R is displayed. The user can then choose to review the step-by-step instruction manual as shown in FIG. 6A by selecting the Rearrange Steps button 488 in FIG. 4R.

Reviewing a Step-by-Step Instruction Manual

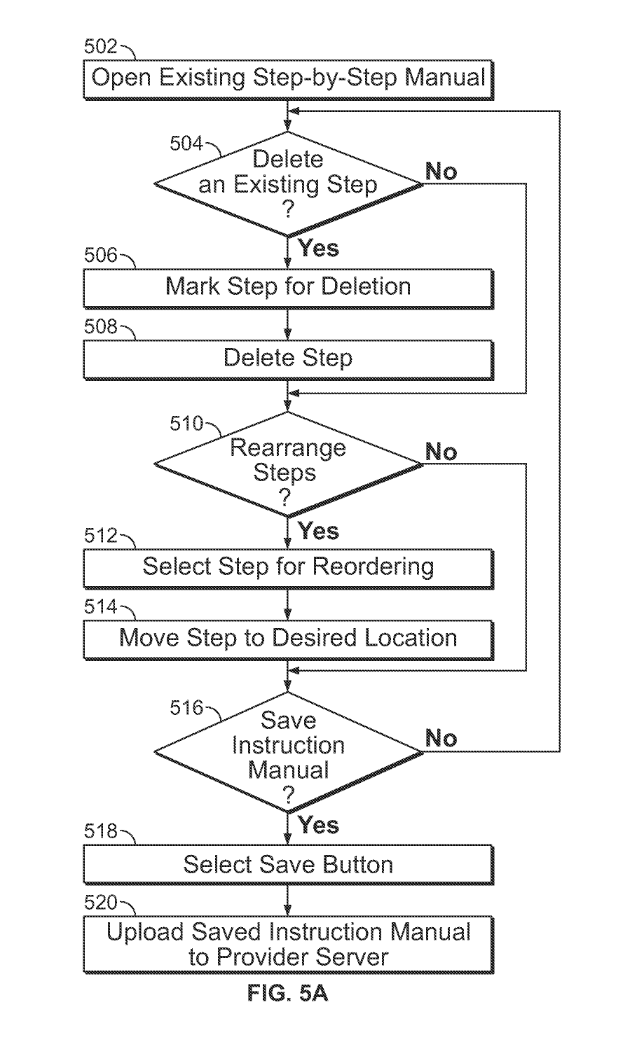

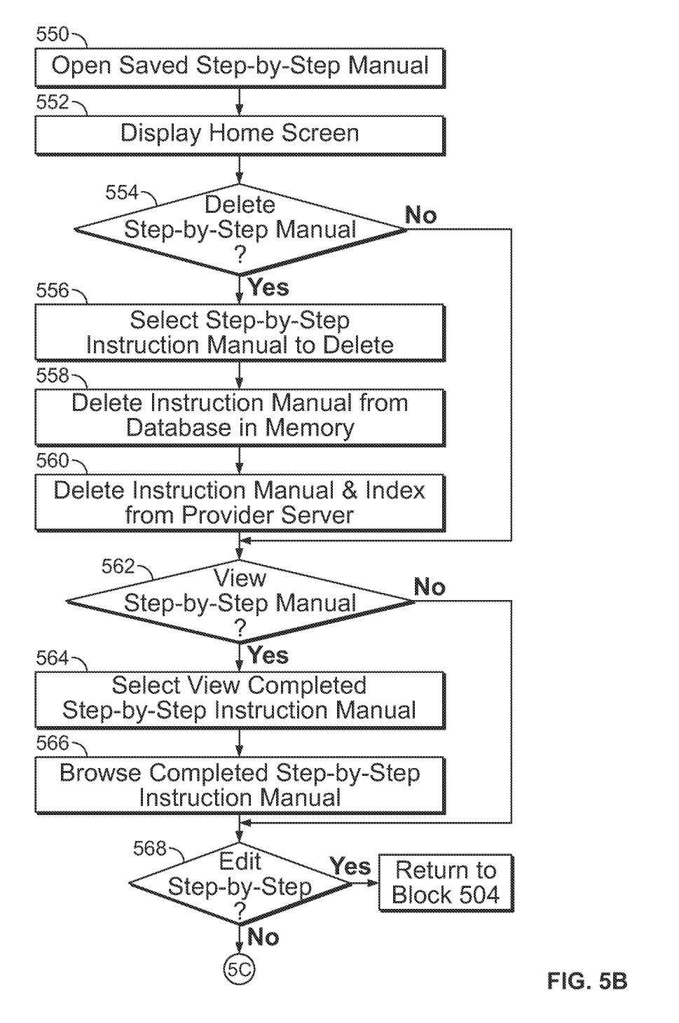

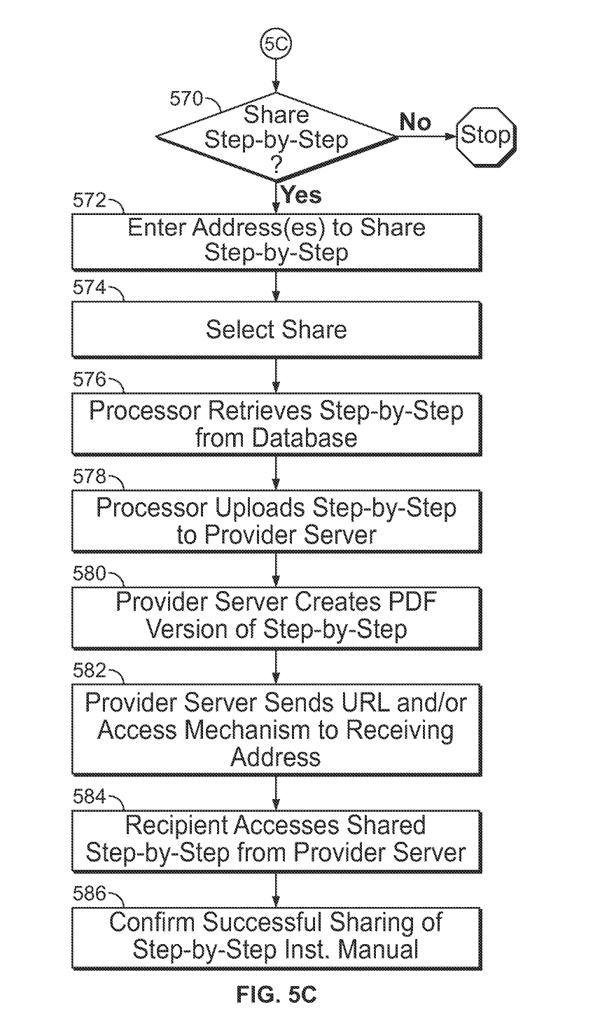

As shown in FIG. 5A, once the step-by-step instruction manual is created and stored in the database of memory 230, the user can review the step-by-step instruction manual. In block 502, the user opens or otherwise accesses an existing step-by-step manual. For example, the existing manual can be stored in a database in memory 230 of computing device 200. The existing manual can be a completed manual or an incomplete manual on which a user has previously worked.

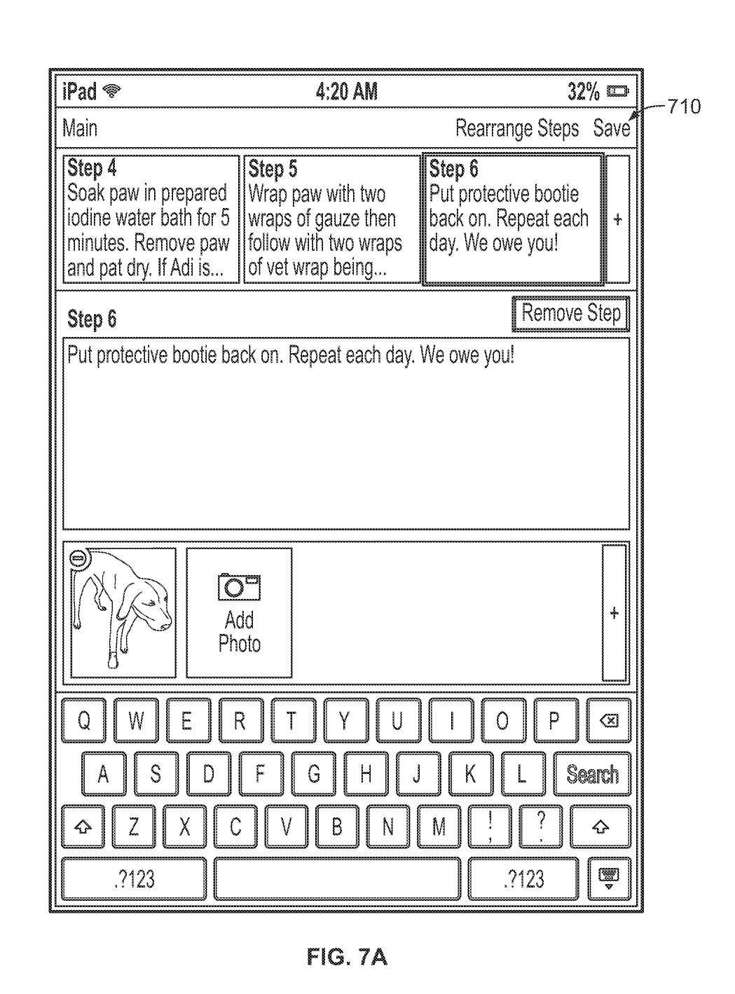

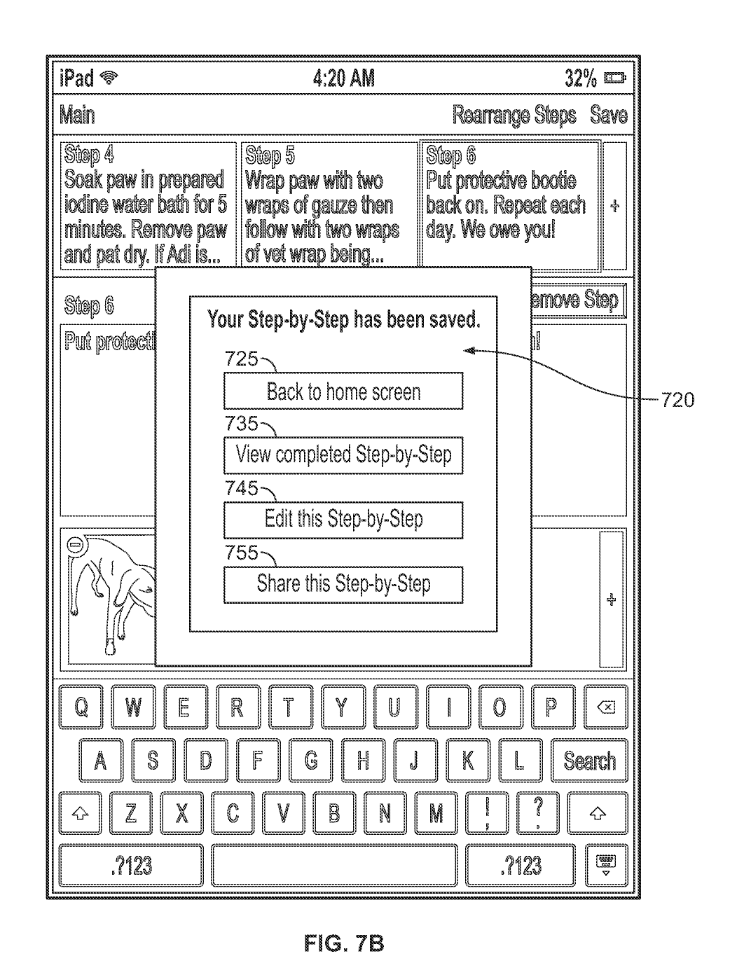

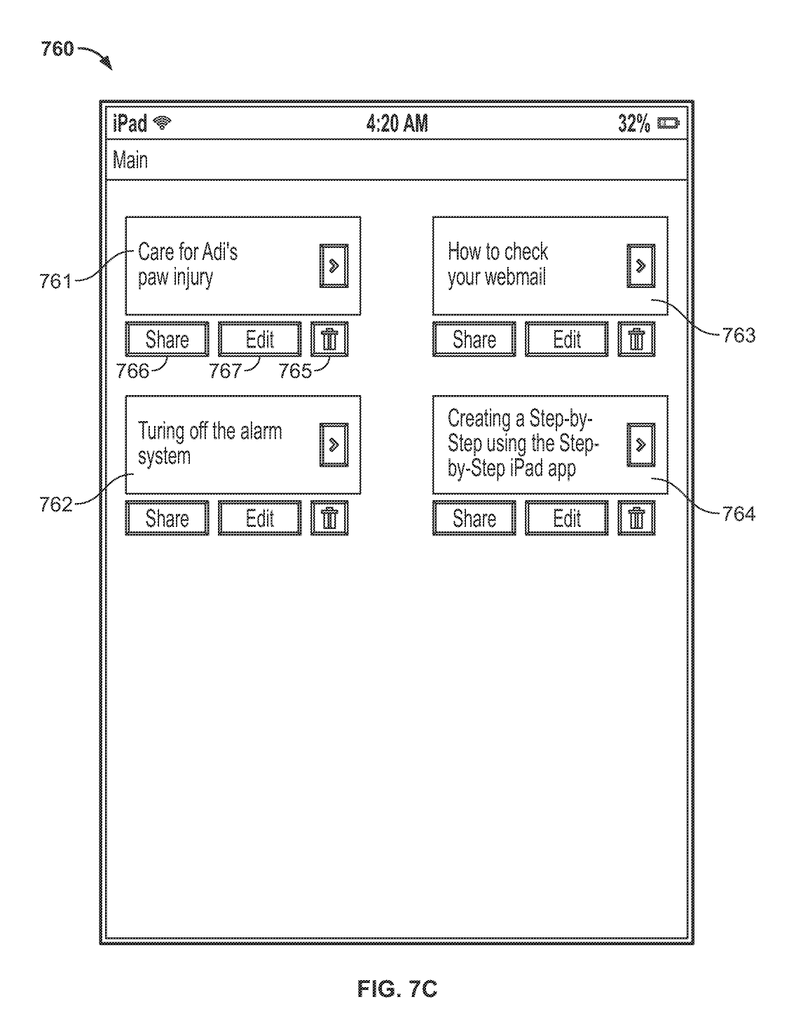

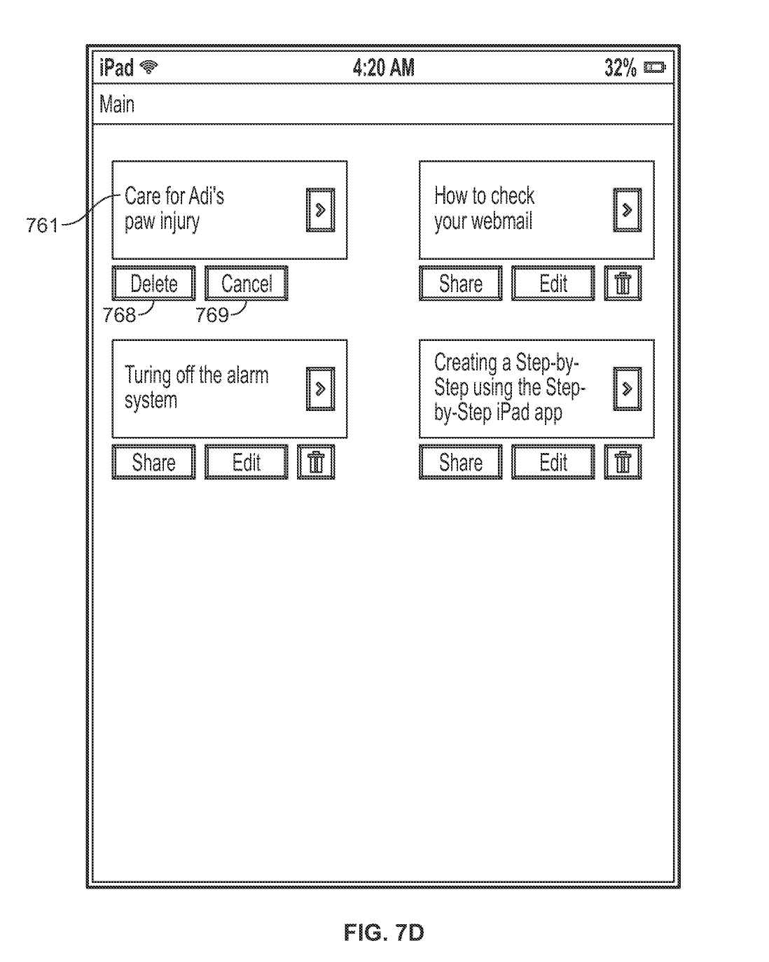

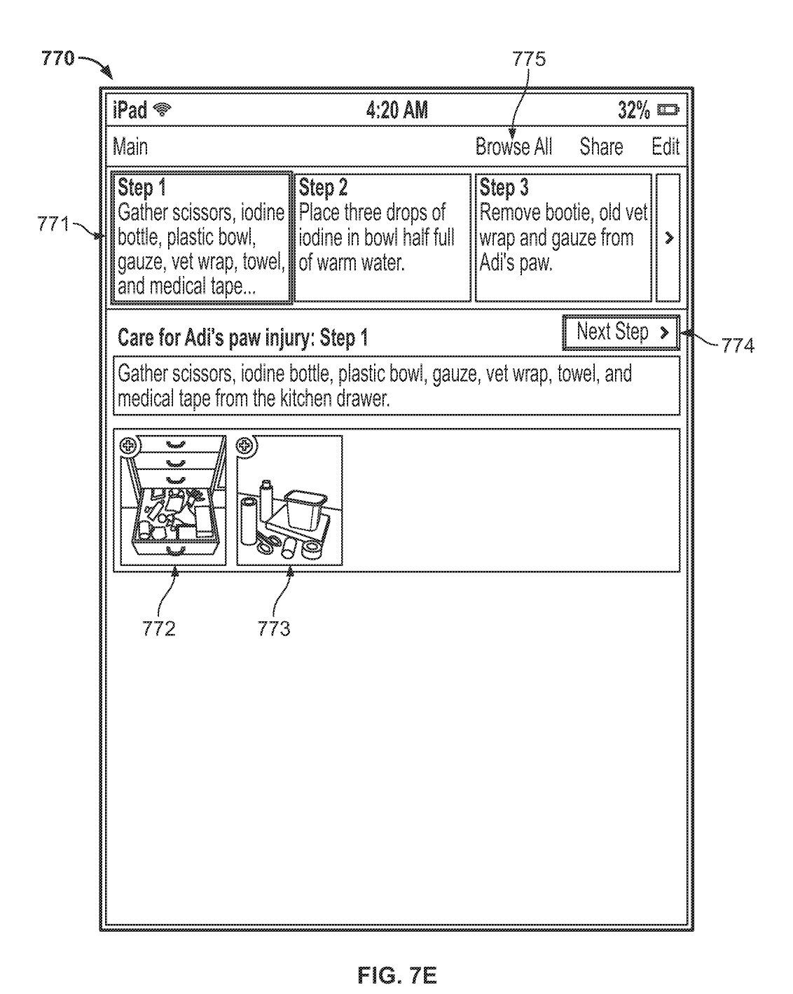

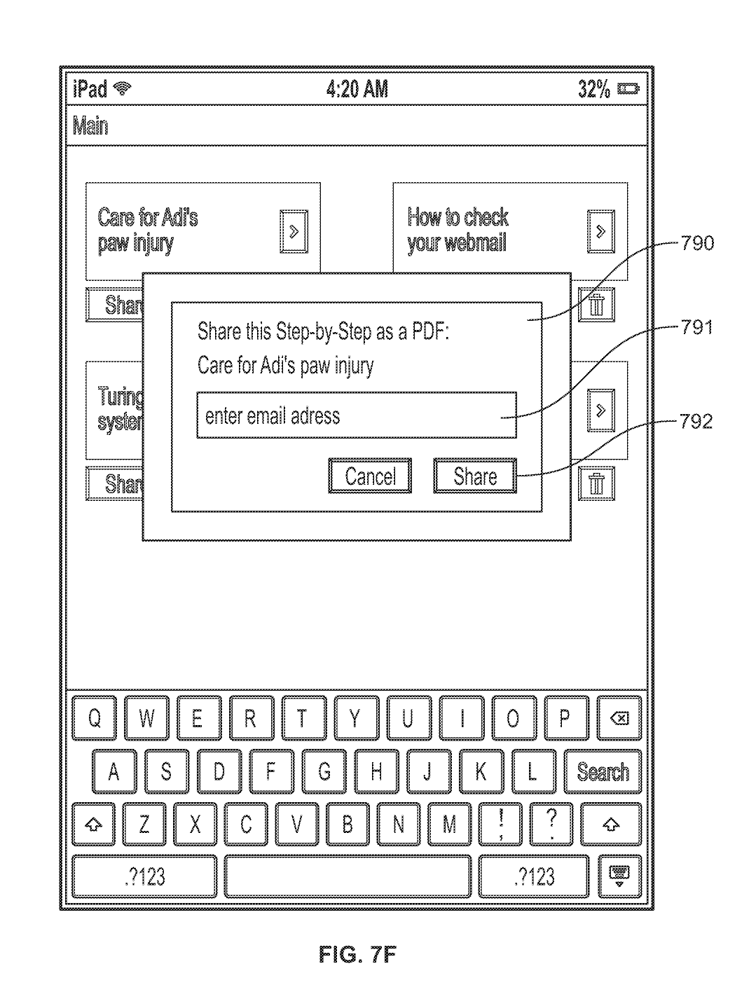

To review an existing instruction manual the user can select the Main (view) button 492 shown in FIG. 4R, for example, which will bring up the Main (view) screen 760 shown in FIG. 7C. The Main (view) screen 760 displays a list of guides 761, 762, 763, 764 stored on the user's computing device. The listed guides 761, 762, 763, 764 are all stored within the local app database in memory 230. A user selects a particular step-by-step instruction guide 761, 762, 763, 764 from the Main view screen 760 by selecting the individual title. The selected guide is loaded from the local app database in memory 230 by loading data associated to the guide ID that was assigned to that particular guide when it was stored in the database in memory 230. Accessing and/or modifying a saved guide can only be performed on the computing device on which the step-by-step instruction manual was created.

FIG. 6A is the main page that is displayed when an existing step-by-step instruction manual is accessed from a database of memory 230 and shows each of the Steps in an existing step-by-step instruction manual. For example, the title 620 of the step-by-step instruction manual is “Care for Adi's paw injury,” and the first step 616 of the instruction manual is “Gather scissors, iodine bottle, plastic bowl, gauze, vet wrap, towel, and medical tape from the kitchen.” The second, third, fourth, fifth, and sixth steps 678, 680, 682, 684, 686 are also shown in the listing of steps in FIG. 6A. A user can edit the steps, rearrange the steps, or delete a step(s) from this screen FIG. 6A. In block 504, a user determines if they would like to delete a step from the existing instruction manual.

If the user would like to delete a step from the existing instruction manual, the process continues to block 506. If the user does not want to delete a step from the existing instruction manual, the process proceeds to block 510. For example, a user may want to delete Step 1 from the listed steps shown in FIG. 6A. As shown in block 506 of FIG. 5A and in FIG. 6B, the user can tap the minus sign 688 next to Step 1 676 to mark that step for deletion. Similarly, the user can swipe across a step to also mark that step for deletion. The minus sign 688 rotates to a vertical position, and a delete button 690 appears next to the text of the step. The user can then select the delete button 690 in block 508, and the step will be removed from the list of steps in the step-by-step instruction manual.

When deleting a step, the unique step ID is stored temporary in a variable. The step is removed visually from the user interface screen, and when the newly edited step-by-step instruction guide is saved after the deletion, the temporary stored step IDS are looked up within the local app database in memory 230 and the found entries (that is, those entries marked for deletion) are removed. The Step Order fields that follow the removed Step in the guide that was being edited are then repopulated to form a linear order with no steps missing.

If the user changes her mind and no longer wants to delete the step, the user can re-select the minus sign 688, and the minus sign 688 will return to a horizontal position, and the delete button 690 will disappear from the screen.

If the user did not want to delete a step from the existing instruction manual in block 504, the user determines if they would like to rearrange the steps of the existing instruction manual in block 510. If the user would like to rearrange the steps in the existing instruction manual, the process continues to block 512. Otherwise, the process continues to block 516. To rearrange the steps of the existing step-by-step manual displayed on the screen, a user can select a step number in one of the blocks as shown in FIG. 6C. For example, a user can select Step 3 680 to be reordered. The step number can change color or otherwise provide a visual or audio cue that the particular step has been selected. As shown in FIG. 6C, a vertical cursor can be displayed in the Step 3 block 680 after the user selects that step. In block 514, the user can re-order the selected step. For example, the user can enter a new step number in the Step 3 block 680 by using the backspace key on the keyboard and typing the desired step number in the block. Similarly, a user can rearrange the steps displayed on the screen by tapping and dragging the three parallel lines shown as step icon 692 in FIG. 6D. When the user taps and drags the step icon 692, the entire step, including block number and text is visually removed from the list of steps and is dragged to its new place in the list. Rearrangement of steps is simply swapping Step Number within the local app database in memory 230. In FIG. 6D, the Step 3 block 680 is shown as being moved below the Step 4 block 682 in the list of steps. If the user changes her mind and no longer wants to rearrange the steps, the user can re-select the Step 3 block 680 and drag it back to its original position.

Saving a Step-by-Step Instruction Manual

As shown in block 516 in FIG. 5B, a user determines if they would like to save the existing step-by-step instruction manual. For example, in FIG. 7A, once a user has edited and rearranged the individual steps of the step-by-step instruction manual, or at any time during the creation or editing process, the user can tap the save button 710 to save the step-by-step instruction manual in a database in memory 230 of the computing device 200. In this manner, a user can return to an in-process or completed step-by-step instruction manual at a later time to make additional changes, such as adding steps, pictures, text, and the like. Additionally, an autosave option is available whereby the user would configure the method of the claimed invention to automatically save the in-process or in-use step-by-step instruction manual at regular intervals or prior to certain editing functions are initiated to reduce the risk or impact of data loss. Earlier versions of the step-by-step instruction manual (that is, those versions of the manual in the database prior to the most recent “save”) can be automatically purged or deleted when the user exits the step-by-step instruction manual application.

After the user selects the save button 710 and the step-by-step instruction manual is saved in a database in memory 230 and uploaded to the provider server 222, where it is also saved in block 520 in FIG. 5A. Dialog box 720 appears on the display of the computing device 200 as shown in FIG. 7B. Dialog box 720 provides the user with a number of options 725, 735, 745, 755 from which to select the next action.

Deleting a Saved Step-by-Step Instruction Manual

When a step-by-step instruction manual is saved, or when a manual is re-opened in block 550 in FIG. 5B after being saved, the user selects “back to home screen” option 725 from dialog box 720, and in block 552 of FIG. 5B, the step-by-step application returns the user to the application Main View screen 760 shown in FIG. 7C. In FIG. 7C, four step-by-step instruction manuals are shown as blocks 761, 762, 763, and 764. From the home screen 760, the user can take action with regard to the step-by-step instruction manuals 761, 762, 763, and 764 such as sharing, editing, and deleting. In block 554, a user determines if they want to delete the step-by-step instruction manual. If the user wants to delete the manual, the process continues to block 556. If the user does not want to delete the manual, the process continues to block 562.

In block 556, one example is illustrated where the user selects the manual to be deleted by selecting the step-by-step instruction manual block 761 and selecting the garbage can icon 765 in FIG. 7C. The tab options changed from “share” 766 and “edit” 767 to “delete” 768 and “cancel” 769 as shown in FIG. 7D. In block 558, the user can then delete that step-by-step instruction manual 761 or cancel the delete action and return to the Main View screen 760 shown in FIG. 7C. The delete button function has the ID of the step-to-step instruction guide attached to it and calls the function to remove it from the database. The deletion removes the entire guide and all the individual Steps linked via the Guide ID from the database in memory 230. Upon deleting the step-by-step manual from the database in memory 230, computing device 200 communicates with the provider server 222 over the network 900, and the step-by-step manual and index is deleted from the provider server 222 in block 560.

Viewing a Step-by-Step Instruction Manual

As shown above in block 554 of FIG. 5B, when a user does not want to delete an entire step-by-step instruction manual, the process continues to block 562 where the user determines if they would like to view a step-by-step instruction manual. For example, in block 564 the user selects “view completed Step-by-Step” option 735 from dialog box 720 in FIG. 7B, and the step-by-step application brings the user to the step-by-step screen 770 shown in FIG. 7E showing the individual step-by-step instruction manual. In block 566, the user can then browse through the individual steps to view the text 771 and pictures 772, 773 in each step. The user can page through the individual steps by selecting the “next step” button 774 to move sequentially through the step-by-step instruction manual. The in-process step-by-step instruction manual is stored locally until it is completed. That is, the step-by-step instruction manual is stored in a database in memory 230 of the computing device 200 until it is completed. Once complete, the finished version is uploaded to the provider server 222, where it is also saved. When the user is finished viewing the step-by-step instruction manual, she can select the “browse all” button 765 to return to the home screen 760 shown in FIG. 7C.

Editing a Step-by-Step Instruction Manual (Redux)

In addition to the manner in which a user can edit the step-by-step instruction manual outlined above, when the home page is displayed on the computer device, as shown in block 568, a user can select “edit this step-by-step” option 745 from dialog box 720 in FIG. 7B, and the step-by-step application will return the user to the editing screen shown in FIG. 6A, where the user can make additional changes to the step-by-step instruction manual as outlined above. If the user does not wish to edit the completed step-by-step instruction manual in block 568, the process continues to FIG. 5C.

Sharing a Step-by-Step Instruction Manual

As shown in block 570 of FIG. 5C, when the user selects “share this step-by-step” option 755 from dialog box 720 in FIG. 7B, the step-by-step application proceeds to block 572 in FIG. 5C and displays dialog box 790 as shown in FIG. 7F. The user can then share the created step-by-step instruction manual as a PDF document. For example, in block 572, the user enters at least one email address in block 791 and selects the “share” button 792 in block 574. In block 576, the processor 220 of computing device 200 retrieves the instruction manual from a database in memory 230 in whatever form it exists (for example, the instruction manual may be in process or may be complete) and uploads the step-by-step instruction manual to server 222 in block 578.

In sharing or otherwise publishing the step-by-step instruction manual, the method of the claimed invention uploads attachments, including photographic, video, and audio files from the user's computing device 200 to the application server 222. The textual information associate with each step is also sent from the user's computing device 200 to the application server.

For example, when a user decides to publish and share a step-by-step guide, the publishing method manages image handling and text submission in two phases. Initially, each image that is used throughout a step-by-step guide is uploaded by the computing device 200 through a server side PHP script. Other types of server-side scripting languages can also be used. The PHP script accepts the image files and stores them locally before returning the image location path back to the user's computing device 200. This return of path occurs for each image one at a time, leading to the user's computing device 200 knowing the location of all used guide images on the web app server 222.

Communication is then made again from the user's computing device 200 to the web app server 222 via POST to a PHP script. Other request methods supported by the HTTP protocol can also be used, where the client (user computing device) needs to send data to the server as part of the request. The PHP loops through the received data and compiles a PDF of the step-by-step guide. This data includes titles, step text, and the accumulated image file paths. Once the PDF is generated in the specific format, the location is returned to the user's computing device 200. The user's computing device 200 then uses this returned web URL for sharing the step-by-step with other users.

Returning to the user interface screens of FIG. 5C, in block 580, the server 222 creates a PDF document version of the instruction manual and a uniform resource locator (URL) and in block 582, the server 222 mails the URL of the PDF document to the email addresses that the user entered in block 791 or otherwise distributes a mechanism with which the recipient of the shared step-by-step instruction manual can access the manual. In block 584, the email recipient can then retrieve the PDF document from the server 222 by accessing the URL. In block 586, the user is then notified whether the step-by-step instruction manual was successfully shared with the intended email addresses.

Having thus described the basic concept of the invention, it will be rather apparent to those skilled in the art that the foregoing detailed disclosure is intended to be presented by way of example only, and is not limiting. In addition to the embodiments and implementations described above, the invention also relates to the individual components and methods, as well as various combinations and sub-combinations within them. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as can be specified in the claims. Accordingly, the invention is limited only by the following claims and equivalents thereto.

The claimed invention is:

1. A computer-implemented method of creating a step-by-step instruction manual comprising:
at a portable electronic step-by-step computing device with a touch screen display;
displaying a title page template on the touch screen display, wherein the title page comprises a title space;
detecting an entered title in the title space and a first finger tap gesture at a location on the displayed title page template;
displaying a step screen page template on the touch screen display, wherein the step screen page comprises a step block and an attachment block;
detecting an entered step in the step block and a second finger tap gesture at a location on the displayed step screen page template;
storing a step-by-step instruction manual in a database based upon at least one of the entered title and the entered step.

2. The computer-implemented method of creating a step-by-step instruction manual of claim 1 further comprising:
detecting an additional finger tap gesture at the attachment block on the displayed step screen page template;
receiving a selected attachment file from a database;
displaying a visual representation of the selected attachment file in the displayed attachment block.

3. The computer-implemented method of creating a step-by-step instruction manual of claim 2, wherein the attachment file includes at least one of a photographic file, a video file, and an audio file.

4. The computer-implemented method of creating a step-by-step instruction manual of claim 1 further comprising:
detecting an additional finger tap gesture at the attachment block on the displayed step screen page template;
creating an attachment file with the portable electronic step-by-step computing device;
displaying a visual representation of the created attachment file in the displayed attachment block.

5. The computer-implemented method of creating a step-by-step instruction manual of claim 4, wherein the created attachment file includes at least one of a photographic file, a video file, and an audio file.

6. The computer-implemented method of creating a step-by-step instruction manual of claim 1, wherein the step-by-step instruction manual is stored in a database in the portable electronic step-by-step computing device.

7. The computer-implemented method of creating a step-by-step instruction manual of claim 6 wherein storing a step-by-step instruction manual includes:
identifying title and step data associated with the step-by-step instruction manual;
creating a main table of the title and step data including a step-by-step ID, a name, and a date on which the step-by-step instruction manual was stored;
creating a steps table including step text, guide ID, and step number data, and the step ID,
creating a local path table that includes local paths to attachment files used within a step; and
indexing the title and step data associated with the step-by-step instruction manual in a local app database in the portable electronic step-by-step computing device.

8. The computer-implemented method of creating a step-by-step instruction manual of claim 1 further comprising:
displaying a roadmap block on the touch screen display, wherein the roadmap block comprises a title block and a step 1 block.

9. The computer-implemented method of creating a step-by-step instruction manual of claim 1 further comprising:
displaying an additional step screen page template on the touch screen display, wherein the additional step screen page comprises an additional step block and an additional attachment block;
detecting an entered additional step in the additional step block and an additional finger tap gesture at a location on the displayed step screen page template.

10. The computer-implemented method of creating a step-by-step instruction manual of claim 9 further comprising:
updating a displayed roadmap block on the touch screen display, wherein the roadmap block comprises a title block and a step 1 block.

11. A portable electronic step-by-step computing device comprising:
a touch screen display;
a processor;
memory; and
one or more programs, wherein the one or more programs are stored in the memory and configured to be executed by the one or more processors, the one or more programs including:
instructions for displaying a title page template on the touch screen display, wherein the title page comprises a title space;
instructions for detecting an entered title in the title space and a first finger tap gesture at a location on the displayed title page template;
instructions for displaying a step screen page template on the touch screen display, wherein the step screen page comprises a step block and an attachment block;
instructions for detecting an entered step in the step block and a second finger tap gesture at a location on the displayed step screen page template;
instructions for storing a step-by-step instruction manual in a database based upon at least one of the entered title and the entered step.

12. The portable electronic step-by-step computing device of claim 11, wherein the one or more programs further include:
instructions for detecting an additional finger tap gesture at the attachment block on the displayed step screen page template;
instructions for receiving a selected attachment file from a database;
instructions for displaying a visual representation of the selected attachment file in the displayed attachment block.

13. The portable electronic step-by-step computing device of claim 12, wherein the attachment file includes at least one of a photographic file, a video file, and an audio file.

14. The portable electronic step-by-step computing device of claim 11, wherein the one or more programs further include:
instructions for detecting an additional finger tap gesture at the attachment block on the displayed step screen page template;
instructions for creating an attachment file with the portable electronic step-by-step computing device;
instructions for displaying a visual representation of the created attachment file in the displayed attachment block.

15. The portable electronic step-by-step computing device of claim 14, wherein the created attachment file includes at least one of a photographic file, a video file, and an audio file.

16. The portable electronic step-by-step computing device of claim 11, wherein the step-by-step instruction manual is stored in a database in the portable electronic step-by-step computing device.

17. The portable electronic step-by-step computing device of claim 16 wherein the instructions for storing a step-by-step instruction manual includes:
instructions for identifying title and step data associated with the step-by-step instruction manual;
instructions for creating a main table of the title and step data including a step-by-step ID, a name, and a date on which the step-by-step instruction manual was stored;
instructions for creating a steps table including step text, guide ID, and step number data, and the step ID,
instructions for creating a local path table that includes local paths to attachment files used within a step; and
instructions for indexing the title and step data associated with the step-by-step instruction manual in a local app database in the portable electronic step-by-step computing device.

18. The portable electronic step-by-step computing device of claim 11, wherein the one or more programs further include:
instructions for displaying a roadmap block on the touch screen display, wherein the roadmap block comprises a title block and a step 1 block.

19. The portable electronic step-by-step computing device of claim 11, wherein the one or more programs further include:
instructions for displaying an additional step screen page template on the touch screen display, wherein the additional step screen page comprises an additional step block and an additional attachment block;
instructions for detecting an entered additional step in the additional step block and an additional finger tap gesture at a location on the displayed step screen page template.

20. The portable electronic step-by-step computing device of claim 19, wherein the one or more programs further include:
instructions for updating a displayed roadmap block on the touch screen display, wherein the roadmap block comprises a title block and a step 1 block.
